(19) United States
(12) Patent Application Publication
(10) Pub. No.: US 2022/0231582 A1
(43) Pub. Date: Jul. 21, 2022

(54) ANGULAR DISPLACEMENT DECODER AND METHOD OF CONSTRUCTION OF THE DEVICE

(71) Applicant: CWJ Power Electronics Inc., Savannah, GA (US)

(72) Inventors: Joao Paulo Pereira de Carvalho, Savannah, GA (US); Paulo Milheiro Caldas Paiv Monteiro, Ega (PT); Antonio Paulo Mendes Breda Dias Coimbra, Coimbra (PT); Tiago Filipe de Pinho Carrilho Goncalves, Covilha (PT)

(73) Assignee: CWJ Power Electronics Inc., Savannah, GA (US)

(21) Appl. No.: 17/394,375

(22) Filed: Aug. 4, 2021

Related U.S. Application Data
(60) Provisional application No. 63/138,799, filed on Jan. 19, 2021.

(51) Int. Cl. H02K 11/225; H02K 1/12; H02K 1/22; H02K 11/01; H02K 5/04; G01D 5/249

(52) U.S. Cl. CPC H02K 11/225; H02K 1/12; G01D 5/249; H02K 11/01; H02K 5/04; H02K 1/22

(57) ABSTRACT

An angular displacement decoder and a method of construction of the device is described. The decoder includes a designated rotor, the rotating part, as a partially metallized disk-shaped target, and a designated stator set, comprising a planar primary coil, as the source of excitation, and a plurality of planar secondary sensing coils, connected and disposed in an innovative manner, as sensing elements, distributed by a plurality of layers of a multilayer printed circuit board (PCB).

In particular embodiments, the planar secondary/sensing coils are disposed as duets, as triplets, or as quartets, each one disposed in a different layer of the multilayer PCB, and the planar primary/excitation coil is disposed in a proper and determined layer of the multilayer PCB, and the partially metallized disk-shaped that rotates around its axis of revolution, is disposed with an air gap at determined distance from the stator set.

### TECHNICAL FIELD

The present disclosure relates to induction-type rotating angular position decoding devices and, more particularly, to an induction-type rotational angular position decoding device used to measure a quantity of something and/or a rate of changing quantity of something.

### BACKGROUND

Among various induction-type rotating angular position-decoding devices, those that are intended to generate two-phase outputs, a sine phase and a cosine phase, in response to a single-phase exciting input, are commonly known as resolvers. Resolver devices are widely used to remotely drive indicator gauges by reading rotary position in several machinery and metering devices, where the reliability of measuring is an important requirement.

Automotive, industrial, and avionics industries have very rigorous accuracy and reliability requirements in angular position decoding devices, where resolvers are commonly known in the state of the art for using in angular position-decoding systems for computing the displacement angles of electric actuator controlled or regulated mechanisms. For example, the measuring of displacement angles in photovoltaic solar tracker systems.

Utility companies use metering devices to measure quantities of several commodities, such as electricity, gas, water and wastewater. Metering devices can include an indicator gauge that indicates the quantity of commodity that has been consumed. For example, the indicator gauge can indicate a volume of water that has been consumed over a period of time by a household or a facility.

An induction-type rotating angular position-decoding device comprises a planar primary coil, as a magnetic flux excitation source, and several planar secondary coils as sensing elements, where primary/excitation coil and secondary/sensing coils are coupled by a varying magnitude magnetic flux. This arrangement, by the principles of the electromagnetic theory, is in real sense an electric transformer. In the operation of a “transformer”, an alternating current, or simply, an alternating periodic waveform, applied into terminals of the primary/excitation coils generates a time-varying magnetic field in the proximity of the secondary/sensing coils. By Faraday's law, the time-varying magnetic field in primary coil induces a time-varying voltage in the secondary coils, as a result of the induction coupling (M) in the enclosed area shaped between primary and secondary coils.

If a conductive target is positioned within the time-varying magnetic field, the induction coupling (M) between the primary coil and the secondary coils will be changed due the Foucault (eddy) currents induced. Thus, if the conductive target is rotating with an angular velocity ω relatively to the stator assembly, the induction coupling (M) also should be time-variant with an angular velocity ω, and consequently the magnitude of the time-varying voltage induced in the secondary coils will be altered by an angular velocity ca, with a frequency f=ω/2π. Therefore, the time-varying voltage in the secondary coils can be measured to compute the angular position of the conductive rotating target.

The time-varying voltage induced in determined secondary coils can have very sensitive magnitudes, being dependent of the air gap distance between the rotor and the stator, susceptible to noisy electromagnetic environments, variance from excitation voltages on primary, uncompensated offset and drift voltages, and another intrinsic and/or extrinsic variances, therefore hard to conditioning and standardizing for proper operation with one practical application.

In accordance to the state of the art, it should be necessary to use a ratiometric or differential arrangement of the secondary coils, which means that secondary coils are connected to one another in series, and in phase opposition, relatively to one another, and the outermost terminals of each secondary coils are used to measure the output differential voltage, that is a function of the angular position of the rotating conductive target. As an expected effect, when the rotating conductive target if far from the stator, which means an infinite air gap distance between the rotor and the stator, the measured differential voltage output should be zero.

Ratiometricity, or simply, ratiometric or differential arrangements, in measurements of electronic analog-sensor signals/quantities, is a state of the art approach in the field of electronics industry.

As examples can be mentioned a linear-variable-differential-transformer (LVDT) and a rotator-variable-differential-transformer (RVDT) that consists of primary coils, secondary coils and a moving core that is moved by the object whose position/angular displacement is being measured.

The LVDT/RVDT devices have been used since about one century ago in servo-control systems in military, radar, sonar, antenna, avionics, robotics, instrumentation, etc.

The LVDT/RVDT secondary coils are connected to one another in series and in phase opposition relatively to one another. As the core moves, the induction coupling (M) between primary and secondary coils changes proportionally, and at outermost terminals from secondary coils can be measured the output differential voltage.

In the case of RVDT, the rotor is a rotating conductive iron-core/angular target and the secondary/sensing coils are disposed in a stator so that one secondary/sensing coil is in-phase with primary/excitation coil and the second secondary/sensing coil is 180° out-of phase with the primary/excitation coil. In a ratiometric method of measurement the signal/quantity of interest are measured with respect to a second signal/quantity as a ratio, such the ratio of the two signals/quantities are simply mathematically expressed as Ratio=x/y, where “x” and “y” are the signals/quantities of interest. In the ratiometric system both of the signals/quantities of interest are proportionally similar, that is, any variance of one will proportionally affect the other, and the ratio effectively remains the same.

In the case of the signals/quantities of interest have exactly the same magnitude in module, the Ratio=1=x/y, that is equivalent to y=x.

In the art, there are several methods to apply the ratiometry in the LVDT/RVDT devices, and analyzing the circuit formed by the two secondary coils, that are in phase opposition to each other, in a way that first secondary coil has an output voltage V_{sec1}, and the second secondary coil has an output voltage V_{sec2}, such leading to an output voltage V_{O} such that V_{O}=V_{sec1}−V_{sec2}.

Thus, two situations can be considered: the absence of the rotating conductive target, and the presence of the rotating conductive target.

In the absence of the rotating conductive target, where the two secondary coils output voltages are equal in module, V_{O}=V_{sec1}−V_{sec2}=0, which is the important result of measuring the output as a differential voltage.

In the presence of the rotating conductive target, where the two secondary coils output voltages are different, V_{O}=V_{sec1}−V_{sec2}≠0 leading to obtain a determined angular displacement that is function of V_{O} given by θ=f(V_{O}).

As conclusion, ratiometricity can be used when are measured sensitive signals/quantities to eliminate variance from the excitation voltages, to compensate for and to eliminate signals/quantities drifts or offsets, and to correct another intrinsic and/or extrinsic variances. As an example, if the induction coupling (M) changes with temperature, then the “delta-over-sum” ratio remains constant with respect to temperature, assuming that both induction coupling (M) change similarly. In other words, the ratio automatically compensates for the variation of the secondary output voltages related to the temperature changes.

However, ratiometricity approach is necessary, but it is not enough to solve the need of using complex, expensive, and energy-consuming analog and/or digital conditioning circuits with the very small magnitudes of the time-varying differential voltages present in the secondary coils, for example in a resolver device.

There are coil assembly sets commonly used in conventional electromechanical resolvers that are comprised of axial windings wound in ferromagnetic cores and several mechanical parts (metallic sheets, screws, etc.). Thus, these types of resolver assemblies are expensive and consume a considerable amount of space.

Also, as known in the state of the art, in order to reduce the cost and size of resolvers, printed circuit boards (PCB) can be used to form the planar stator's primary and secondary coils of the resolvers.

The design of planar coils for induction-type rotating angular sensors commonly known in the art requires that the coils be spread across multiple layers of the multilayer PCB.

As presented, in a presence of a ratiometric measurement approach, when the conductive target is far from the stator, which means an infinite air gap distance between the rotor and the stator, the measured output differential voltage at outermost terminals from secondary coils should be zero, in order to be sure that in normal operation the measured output of differential voltage is exclusively due to the presence of the conductive target.

However, from the electromagnetism theory, as the different planar secondary/sensing coils are disposed at different distances from the planar primary/excitation coil, due the difference of induction coupling (M) between primary and secondary coils, on the different layers, appears as a non-zero voltage, an offset voltage, as output of the differential voltage. In such case, as the magnitudes of the measured output of differential voltage due the presence of conductive target can be in the same order of magnitude of the offset voltages, would be hard to solve the problem without the use of complex, expensive and energy-consuming analog and/or digital conditioning circuits.

As a consequence of this drawback, most of the industry-succeeded induction-type rotational angular sensors based in multilayer PCB currently known in the art are based in planar secondary/sensing coils disposed in the same PCB layer, and sometimes, at most, the planar primary/excitation coils are disposed in a different layer of the planar secondary/sensing coils (e.g. in a double-layer PCB).

There are applications where the coils are distributed by several layers to obtain a higher inductance, resulting from the sum of the several unitary contributions of each winding coil inductance of each layer. In this case, the differences in induction couplings (M) are not an issue, because the only objective of a higher number of PCB layers is the increment of the total inductance. However, these approaches are not well suited when the main objective is the obtaining of a multitude of planar secondary/sensing coils, which in several applications are more than one dozen.

The increment of the cost from a double-layer PCB to a multilayer PCB is negligible when compared to the use of complex, expensive, and energy-consuming analog and/or digital conditioning circuits to solve the issues of the offset voltages between the different planar secondary/sensing coils.

There is a disclosure of methods and systems for implementing a rotating-sensing device based in principles of magnetism.

U.S. Pat. No. 10,444,035, describes a rotation sensing device that includes a magnet, a magnetic field sensor configured to sense a magnetic field of the magnet, and a flux conductor configured to alter the magnetic field of the magnet, wherein the flux conductor is mounted onto a rotating target.

However, this rotation-sensing device has the drawback of the need of a rotating target equipped with a magnet, which would be harder and more expensive to build than a rotating target element based only in a partially metallized disk-shaped part. Besides that, the device uses a magnetic sensor that may be an energy-consuming device that can be disadvantageous in power-constrained and mass-market applications, and may not be an universal solution because several manufacturers of devices only use rotating conductive targets with a partially metallized disk-shaped target.

There are disclosures of rotating angular devices based in induction principles, comprising planar winding coils, commonly known in the art, that require that the coils be spread across multiple layers of the multilayer PCB.

U.S. Pat. No. 10,415,952 describes an angular position sensor device that includes at least one planar excitation coil and at least four planar sensing coils positioned within the interior of at least one planar excitation coil, each of the at least two compound sensing coils (in fact, each two of four planar sensing coils) comprising a clockwise winding portion sensing coil positioned opposite a counterclockwise of another winding portion sensing coil, and a rotating conductive target element comprising a sector aperture, that is positioned in overlying relation to at least one planar excitation coil, separated from the at least one planar excitation coil, by an air gap.

It is noted that, from the electromagnetism theory and in here, “coil” is defined as one or more turns, usually roughly circular or cylindrical, of current carrying wire designed to produce a magnetic field, to provide electrical resistance or inductance.

The patent discloses “at least” two planar sensing coils but doesn't disclose the way of connecting “the more than two” sensing coils. In the case, it doesn't disclose the way of connecting “the more than four” planar sensing coils, because the mentioned “two planar sensing coils”, in accordance with the art, are “four planar sensing coils”.

In fact, each two secondary coils are connected to one another in series, and in phase opposition, relatively to one another, and the outermost terminals from each secondary coil are used to measure the output differential voltage, that is a function of the angular position of the rotating conductive target, as described in the common art of a ratiometric measurement approach, as is the case of a RVDT device.

With reference to FIG. 1, it is presented the equivalent electric circuital arrangements of a disclosed embodiment of the four planar sensing/secondary coils and one planar excitation/primary coil, as mentioned above. Also, it is disclosed that the four planar sensing/secondary coils and at least one planar excitation/primary coil are disposed in a same layer of a PCB. The planar excitation/primary coil can be disposed in a different layer of the PCB, relatively to the planar sensing/secondary coils.

With reference to FIG. 2, it is presented an equivalent physical arrangement of a disclosed embodiment of the four planar sensing/secondary coils and one planar excitation/primary coil, which are disposed in a same layer of a PCB.

An identified drawback is the case of small diameter conductive targets, e.g. with diameters as low as 10 mm, and in conditions of high lengths of air gaps between rotating conductive targets and the stator, higher than 10 mm, can lead to obtaining differential voltage signals outputs of very small magnitudes, therefore leading to very low sensitivity, with the consequences of low accuracy, precision, linearity, and resolution, that may lead to complex, expensive, and energy-consuming analog and/or digital conditioning and/or processing circuitry, which can be disadvantageous in power-constrained and/or mass-market applications.

Another identified drawback, with reference to FIG. 3 and FIG. 4, is the case of the rotating conductive targets with about 180° of partially metallized disk-shaped, where there are several angular positions of rotation wherein the system is characterized by having ranges of measuring angles of blindness, with no way of directly decode the angular positions of rotation, that in the case of designated “sine-phase” is in the ranges between 0° and 90° and between 180° and 270°, and in the case of designated “cosine-phase” is in the range between 90° and 180° and between 270° and 360°.

With reference to FIG. 4, this may be the motive of the disclosed invention privileges as preferred embodiment a sector aperture of the rotating conductive disk with a central angle of 90°. As can be observed, the designated “sine-phase” and the designated “cosine-phase” are perfectly characterized in all the range, from 0° to 360°. However, this characteristic may lead to a limitation of use only for field application systems that are characterized by having specific shapes of the rotating conductive targets.

Another identified drawback is the disclosed source of excitation being a sinusoidal alternating current source coupled to a planar excitation coil. It is substantially easier to generate non-sinusoidal waveforms, as alternating periodic waveforms, e.g. a square wave, which are commonly available in the art of electronics.

U.S. Pat. No. 7,576,533, describes an angular position sensor device that includes a partially metalized disk, such as a rotating partially conductive target element, that moves around its axis of revolution, and a stator that includes a planar excitation/primary coil and several planar sensing/secondary coils, by which the secondary coils are arranged essentially symmetrically in pairs relatively to the axis of revolution, so as to form one or more pairs of secondary coils where each pair is connected to one another in series and in phase opposition relative to one another, and to the terminals of a measuring element that can generate one output signal that depends of the voltage at the terminals of the pair.

That patent mentions one or more pairs of planar secondary/sensing coils, but in fact only discloses the way of connecting two pairs of secondary/sensing coils. Therefore it does not disclose possible embodiments with the ways of connecting “the more than two pairs” of secondary/sensing coils.

In fact, each two secondary/sensing coils are connected to one another in series and in phase opposition relatively to one another, disposed so that one secondary/sensing coil is in-phase with primary/excitation coil and the second secondary/sensing coil is 180° out-of phase with the primary/excitation coil, and the outermost terminals from each secondary/sensing coil are used to measure the output differential voltage that is function of the angular position of the rotating conductive target, as well described in the common art of a ratiometric measurement approach, as in the case of the example of a RVDT. Also it discloses that the output differential voltages are measured by comprising two comparators combined with each pair of secondary/sensing coils, also in accordance with the common art of electronics, that effectively may lead to obtaining, at the comparators outputs, square waveforms, which are not waveform characteristics of designated “sine-phase” and a designated “cosine-phase” voltage outputs of decoding angular positions of rotation, as shown in the common art of resolver devices.

Also is described a rotor, comprising a rotating partially metalized disk that is arranged on a rotating moving body, such that the rotating disk is integral in rotation along the axis of revolution of the rotating body, where the rotating partially metalized disk is metallized on a surface that corresponds to a half disk, 180°, which is also the common art of most of the manufacturers of water meter devices. Thus, there are water meter devices where the rotating partially metalized disks are metallized in different ratio of metalized surfaces, e.g. one third of the circle surface, 120°.

An identified drawback is the case of small diameter of conductive targets, e.g. in the range of diameters as low as 10 mm, and in conditions of high lengths of air gaps between rotating conductive targets and the stator, higher than 10 mm, can lead to obtain differential voltage signals outputs of very low magnitudes, therefore leading to very low sensitivity, with the consequences of low accuracy, precision, linearity, and resolution, that may lead to complex, expensive, and energy-consuming analog and/or digital conditioning and/or processing circuits, which can be disadvantageous in power-constrained and/or mass-market applications.

Another identified drawback is the case of the rotating conductive targets (the rotor) with about 180° of partially metallized disk-shape, where there are several angular positions of rotation wherein the system is characterized by having ranges of blindness, with no way of directly decode the angular positions of rotation, that in the case of designated “sine-phase” is in the ranges between 0° and 90° and between 180° and 270°, and in the case of designated “cosine-phase” is in the range between 90° and 180° and between 270° and 360°.

U.S. Pat. No. 10,330,498, describes a sensor arrangement for the contactless sensing of angles of rotation on a rotating part that includes a disk-shaped target, a coil arrangement of three flat detection coils uniformly distributed on the circumference of a circle, and an evaluation and control unit.

The disk-shaped target is coupled to the rotating part, that includes at least two metal surfaces, that influence the inductances in the flat detection coils due to Foucault currents effects as a function of the degree of overlap, which can generate at least one piece of information for ascertaining the instantaneous angle of rotation of the rotating part, in connection with the coil arrangement. The evaluation and control unit can generate essentially sinusoidal evaluation signals that represent the changes in inductance of the detection coils and can evaluate them for calculating the angle of rotation.

The patent describes an arrangement of stator that does not include a planar primary/excitation coil, being the voltage output signals obtained by computing the changes in inductance on the detection coils in accordance with the rotating of the disk-shaped target.

The disk-shaped target includes two metal surfaces arranged opposite to one another on the circumference of the circle, each of the metal surfaces having an opening angle with a value in the range 100° to 120°, or four metal surfaces arranged uniformly distributed on the circumference of the circle, each of the metal surfaces having an opening angle with a value in the range of 50° to 60°. The sense of rotation of the disk-shaped target is computed from the relative angular position of the at least two metal surfaces (up-to four) that overlap the detection coils.

This is a drawback because the rotor, comprising a rotating partially metalized disk that is arranged in special manner, is not compliant with devices where a surface corresponds to a half disk, 180°, or one third disk 120°, as common art of for example of water meter devices.

Another identified drawback is the case of small diameter of conductive targets, e.g. in the range of diameters lower than 10 mm, and in conditions of high lengths of air gaps between rotating conductive targets and the stator, higher than 10 mm, can lead to obtaining inductances' outputs of very small magnitudes, leading to very low sensitivity, with the consequences of low accuracy, precision, linearity, and resolution, that may lead to complex, expensive, and energy-consuming analog and/or digital conditioning and/or processing circuitry, which can be disadvantageous in power-constrained and/or mass-market applications.

Accordingly the identified drawbacks and some innovative practices, the current invention has as object an angular displacement decoder, comprising:
The use of the partially metallized disk-shaped targets that includes one metal surface having a multitude of opening angles in the range between 90° (one quart of the circle) to 270° (three quarts of the circle).
Ability to directly generate the two-phase of time-varying output voltages, designated Vₛᵢₙ and designated V_{cos}, as characteristic of a resolver device, as a preferred embodiment, which may be arranged in such a manner that the time-varying output voltages are 90° or 120° phase-shifted (e.g. sinθ and sin(θ+90°), or e.g. sinθ and sin(θ+120°)).
The use of small diameter conductive targets, for example in the range of diameters as low as 10 mm, and in conditions of high lengths of air gaps between rotating conductive targets and the stator (higher than 10 mm), still allow obtaining time-varying output voltages of easily measurable magnitudes, several times higher than the prior art (up-to 4 times, in a particular embodiment).
Ability to obtain a higher sensitivity than the prior art, with the consequences of higher accuracy, precision, linearity, and resolution, with the use of simple, not expensive, and low energy-consuming analog and/or digital conditioning and/or processing circuits, which can be advantageous in power-constrained and/or mass-market applications.
Easy manufacturing of the designated stator set part, that comprises the planar electrical connections layer, the EMI shielding layer, the primary/excitation coil layer, and the planar secondary/sensing coils layers, connected and disposed in innovative manner, that allows all the interconnections of signals to be addressed through the minimal use of vias, half-vias, pads, and/or conductive tracks, among the PCB layers.

### SUMMARY OF THE INVENTION

The present invention provides a system for decoding an angular displacement of a rotating partially metallized disk-shaped target and a method of construction of the device with improved sensitivity, accuracy, precision, linearity, and resolution of the inductive angular displacement decoder device which utilizes innovative multilayer planar coils arrangement and connections, by using multilayer printed circuit boards (PCB), in a form of a cylindrical stack. In different embodiments, a planar primary coil is the source of excitation, and a plurality of planar secondary coils, connected and disposed in innovative manner are sensing elements, distributed by a plurality of layers of a multilayer printed circuit board (PCB).

In one embodiment, it is object of the present invention to provide an angular displacement decoder comprising multilayer planar coils, the said decoder including a designated rotor, as the rotating conductive target, as a partially metallized disk-shaped target, and a designated stator set comprising a planar primary coil as the source of excitation, and a plurality of planar secondary coils, connected and disposed in innovative manner, as sensing elements, distributed by a plurality of layers of a multilayer printed circuit board (PCB).

The planar primary/excitation coil is disposed in one determined layer of multilayer PCB. The planar secondary/sensing coils are arranged in duets, not in pairs, as they are not directly connected between them, being disposed symmetrically relatively to the axis of revolution, one rotated 180° relatively to another, and are disposed in different determined layers of the same multilayer PCB, in a form of a cylindrical stack. The partially metallized disk-shaped target, that rotates around the referred axis of revolution, is disposed with an air gap, at determined distance from the stator set.

The mentioned rotor and the mentioned stator set are aligned perpendicularly with a common axis of revolution inside of the same delimitation line of the circumference of the entire decoder set, shaped as a cylindrical stack formed by the different layers of the multilayer PCB.

The rotor comprises a rotating conductive target, as a partially metallized disk-shaped target so as to cause variations in the induction coupling (M) between the planar primary/excitation coil and the planar secondary/sensing coils due to Foucault currents effects, as a function of the overlap in stator set, in response to its current rotating position, with underlying variations of the induced differential voltages in the planar secondary/sensing coils.

A first coil set of two duets, disposed in two different layers of the multilayer PCB and connected in determined way, generates one-phase of time-varying output voltage designated Vₛᵢₙ, and a second coil set of two duets, disposed in another two different layers of the multilayer PCB and connected in another determined way, generate another-phase of time-varying output voltage designated V_{cos}, leading to obtain a resolver device. The first coil set and the second coil set generate the two phases of time-varying output voltages, designated Vₛᵢₙ and designated V_{cos}, as characteristic of a resolver device, are arranged in such a manner that the time-varying output voltages are 90° phase-shifted (e.g. sinθ and sin(θ+90°)).

In accordance with the common art of ratiometric measurement approach, two planar secondary/sensing coils can be connected to one another in series, and in phase opposition, relatively to one another, and the innermost terminals of each secondary coils can be used to measure the output differential voltage, that is function of the angular position of the rotating conductive target, as shown in FIG. 2. This approach is valid for two planar secondary/sensing coils, but cannot be directly used here, because instead of two planar secondary/sensing coils, there are four planar secondary/sensing coils in each coil set of two duets. As known, it is necessary to generate the time-varying output voltages 90° phase-shifted (e.g. sinθ and sinθ+90°)), in the two coil sets of two duets.

Therefore, using the same reasoning of ratiometric measurement approach, by disposing the planar secondary/sensing coils in order to generate the desired coil output voltages with negative or positive magnitudes, in accordance with each relative quadrant where each planar secondary/sensing coils pertains on the trigonometric circle, and connecting them in a way that final summation of the unitary contributions of all planar secondary/sensing can be zero, in the absence of the partially metallized disk-shaped target, a similar and equally usable result can be obtained.

According to the present invention and current embodiment, the rotation displacement decoder device has been described to have two-phase time-varying output voltages as characteristically generated by a resolver, but it can also be built to have three-phase time-varying output voltages as characteristically generated by a synchro device, which in such case, should be designed having three sets of planar secondary/sensing coils, arranged in such a manner that the time-varying output voltages are 120° phase-shifted (e.g. (e.g. sinθ, sin(θ+120°) and sin(θ+240°)). The same reasoning is valid to build multi-phase devices of time-varying output voltages with different number of phases.

In another particular embodiment, it is object of the present invention to provide an angular displacement decoder comprising multilayer planar coils, the said decoder including a designated rotor, as the rotating conductive target, as a partially metallized disk-shaped target, and a designated stator set comprising a planar primary coil as the source of excitation, and a plurality of planar secondary coils, connected and disposed in an innovative manner, as sensing elements, distributed by a plurality of layers of a multilayer printed circuit board (PCB).

The planar primary/excitation coil is disposed in one determined layer of multilayer PCB, and the planar secondary/sensing coils are arranged in triplets (not directly connected between them), disposed with an angular shift of 120°, relatively to the axis of revolution (ones rotated 120° relatively to the others), and are disposed in different determined layers of the same multilayer PCB, in a form of a cylindrical stack, and the partially metallized disk-shaped that rotates around the same axis of revolution, is disposed with an air gap at determined distance from the stator set.

The mentioned rotor and the mentioned stator set are aligned perpendicularly with a common axis of revolution inside of the same delimitation line of the circumference of the entire decoder set, shaped as a cylindrical stack formed by the different layers of the multilayer PCB.

The rotor comprises a rotating conductive target, as a partially metallized disk-shaped target so as to cause variations in induction coupling (M) between the planar primary/excitation coil and the planar secondary/sensing coils due to Foucault currents effects, as a function of the overlap in stator set, in response to its current rotating position, with underlying variations of the induced differential voltages in the planar secondary/sensing coils.

A first coil set of two triplets, disposed in two different layers of the multilayer PCB and connected in a determined way, generates one-phase of time-varying output voltage designated Vₛᵢₙ, second coil set of two triplets, disposed in another two different layers of the multilayer PCB and connected in another determined way, generate another phase of time-varying output voltage designated V_{cos}, leading to obtain a resolver device. The first coil set and the second coil set generate the two-phase of time-varying output voltages, designated Vₛᵢₙ and designated V_{cos}, as characteristic of a resolver device, which in the case are arranged in such a manner that the time-varying output voltages are 120° phase-shifted (e.g. sinθ and sin(θ+120°)).

In accordance with the common art of ratiometric measurement approach, two planar secondary/sensing coils can be connected to one another in series, and in phase opposition, relatively to one another, and the outermost terminals of each secondary coil can be used to measure the output differential voltage that is function of the angular position of the rotating conductive target. This approach is valid for two planar secondary/sensing coils, but cannot be directly used here, because instead of two planar secondary/sensing coils, there are six planar secondary/sensing coils in each coil set of two triplets. As known, it is necessary to generate the time-varying output voltages 120° phase-shifted (e.g. sinθ and sin(θ+120° between the two coil sets of two triplets.

Therefore, using the same reasoning of ratiometric measurement approach, by disposing the planar secondary/sensing coils in order to generate the desired coil output voltages with negative or positive magnitude, in accordance with each relative quadrant where each planar secondary/sensing coils pertains on the trigonometric circle, and connecting them in a way that the final summation of the unitary contributions of all planar secondary/sensing can be small, in the absence of the partially metallized disk-shaped target, a similar and equally usable result can be obtained.

According to the present invention and embodiment, the rotation displacement decoder device has been described to have two-phase time-varying output voltages as characteristically generated by a resolver, but it can also be built to have three-phase time-varying output voltages as characteristically generated by a synchro device, which in such case, should be designed three sets of planar secondary/sensing coils, arranged in such a manner that the time-varying output voltages are 120° phase-shifted (e.g. sinθ, sin(θ+120°) and sin(θ+240°)). The same reasoning is valid to build multi-phase devices with different number of phases.

In another particular embodiment, it is object of the present invention to provide an angular displacement decoder comprising multilayer planar coils, the said decoder including a designated rotor, as the rotating conductive target, as a partially metallized disk-shaped target, and a designated stator set comprising a planar primary coil as the source of excitation, and a plurality of planar secondary coils, connected and disposed in an innovative manner, as sensing elements, distributed by a plurality of layers of a multilayer printed circuit board (PCB).

The planar primary/excitation coil is disposed in one determined layer of multilayer PCB, with the planar secondary/sensing coils arranged in quartets (not directly connected between them), disposed with an angular shift of 90° relatively to the axis of revolution (each one rotated 90° relatively to the previous one), disposed in different determined layers of the same multilayer PCB, in a form of a cylindrical stack. The partially metallized disk-shaped rotates around its axis of revolution, disposed with an air gap at determined distance from the stator set.

The mentioned rotor and the mentioned stator set are aligned perpendicularly with a common axis of revolution inside of the same delimitation line of the circumference of the entire decoder set, shaped as a cylindrical stack formed by the different layers of the multilayer PCB.

The rotor comprises a rotating conductive target, as a partially metallized disk-shaped target so as to cause variations in induction coupling (M) between the planar primary/excitation coil and the planar secondary/sensing coils due to Foucault currents effects, as a function of the overlap in stator set, in response to its current rotating position, with underlying variations of the induced differential voltages in planar secondary/sensing coils.

A first coil set of two quartets, disposed in two different layers of the multilayer PCB and connected in a determined way, generates one phase time-varying voltage output designated Vₛᵢₙ, and a second coil set of two quartets, disposed in others two different layers of the multilayer PCB and connected in another determined way, generates another phase time-varying output voltage designated V_{cos}, leading to obtaining a resolver device. The first coil set and the second coil set generate the two-phases of time-varying voltages outputs, designated Vₛᵢₙ and V_{cos}, as characteristic of a resolver device, which in the case are arranged in such a manner that the time-varying output voltages are 90° phase-shifted (e.g. sinθ and sin(θ+90°)).

In accordance with the common art of ratiometric measurement approach, two planar secondary/sensing coils can be connected to one another in series, and in phase opposition, relatively to one another, and the innermost terminals of each secondary coil may be used to measure the output differential voltage, that is function of the angular position of the rotating conductive target, as shown in FIG. 2. This approach is valid for two planar secondary/sensing coils, but cannot be directly used here, because instead of two planar secondary/sensing coils, there are eight planar secondary/sensing coils in each coil set of two quartets. As known, it is necessary to generate the time-varying output voltages 90° phase-shifted (e.g. sinθ and sin(θ+90°)), between the two coil sets of two quartets.

Therefore, using the same reasoning of ratiometric measurement approach, by disposing the planar secondary/sensing coils in order to generate the desired output voltage with negative or positive magnitude, in accordance with each relative quadrant where each planar secondary/sensing coils pertains on the trigonometric circle, and connecting them in a way that final summation of the unitary contributions of all planar secondary/sensing can be zero, in the absence of the partially metallized disk-shaped target, a similar and equally usable result can be obtained.

According to the present invention and current embodiment, the rotation displacement decoder device has been described to have two phases of time-varying voltages as characteristically generated by a resolver, but it can also be built to have three-phase of time-varying voltages as characteristically generated by a synchro device, which in such case, should be designed three sets of planar secondary/sensing coils, arranged in such a manner that the time-varying voltages are 120° phase-shifted (e.g. sinθ, sin(θ+120°) and sin(θ+240°)). The same reasoning is valid to build multi-phase devices of time-varying voltages.

The present invention additionally provides a method of construction of an angular displacement decoder of a rotating conductive target, as a partially metalized disk-shaped target, in five steps: (i) choose the desired number of phases of time-varying output voltages; (ii) choose the angle shifting between the phases of time-varying output voltages; (iii) choose the factor of sensitivity (FS) of the device by computing the number of planar secondary/sensing coils (iv) place the planar secondary/sensing coils distributed by the layers of the multilayer printed circuit board (PCB) and in accordance with individual coils polarity voltages versus the relative position in the trigonometric circle to obtain the desired time-varying output voltages for each angular position; (v) arrange the individual physical circuit of planar secondary/sensing coils for obtaining the maximal symmetry relatively to the axis of revolution and the minimal use of vias, half-vias, pads, and/or conductive tracks, among the PCB layers.

In step (i), the desired number of phases of time-varying output voltages is chosen, which means the assessment of the number of phases of time-varying voltages that shall be characteristically generated by a determined device, from one-phase devices to multi-phase devices. For example, if the device has to be two-phase time-varying output voltages is commonly called a resolver, or if the device has to be three-phase time-varying output voltages is commonly called a synchro.

In step (ii) is chosen the angle shifting between the phases of time-varying output voltages, which means the assessment of the angle shifting between the phases of time-varying output voltages, where typically are designed 90° phase-shifted (e.g. sinθ, sin(θ+90°) and sin(θ+180°)) or 120° phase-shifted (e.g. sinθ, sin(θ+120° and sin(θ+240°)). For example, if the device has two-phase of time-varying output voltages 90° phase-shifted ((e.g. sinθ, sin(θ+90°)) it is commonly called a resolver, or if the device has three-phase of time-varying output voltages 120° phase-shifted (e.g. sinθ, sin(θ+120° and sin(θ+240°)) it is commonly called a synchro.

In step (iii), the factor of sensitivity (FS) of the device is chosen. This factor can be implemented by computing the number of planar secondary/sensing coils, which means the assessment of the magnitudes of time-varying output voltages; they are proportional to the number of individual planar secondary/sensing coils used to generate each time-varying output voltage divided by two: FS=(number of coils)/2, or equivalently (number of coils)=FS×2.

The factor of sensitivity (FS) of a current device is a relative factor that is obtained by comparing the sensitivity of the current device with the sensitivity of a basic arrangement of two planar secondary/sensing coils connected to one another in series, and in phase opposition relatively to one another, and the innermost terminals of each secondary coils are used to measure the output differential voltage, that is function of the angular position θ of the rotating conductive target. In this case, FS is considered equal to 1, from FS=(number of coils)/2=2/2=1.

Step (iv) comprises the placement of planar secondary/sensing coils distributed by the layers of the multilayer printed circuit board (PCB) in accordance with individual coils polarity voltages versus the relative position in the trigonometric circle to obtain the desired time-varying output voltages by each angular position. The placement of planar secondary/sensing coils should comply with the ratiometric measurement approach where each planar secondary/sensing coil disposed clockwise should have a planar secondary/sensing coils disposed counterclockwise and symmetrically rotated 180° relatively to the axis of revolution.

Step (v) comprises the arrangement of each individual physical circuit of planar secondary/sensing coils addressed through obtaining the maximal symmetry of the whole set of the designated stator, relatively to the axis of revolution and the minimal use of vias, half-vias, pads, and/or conductive tracks, among the PCB layers. This step uses several principles of electromagnetism theory that allow the simplifying of the PCB routing of secondary/sensing coils windings in such way that different physical arrangements lead to the same equivalent electrical circuits.

With reference to FIG. 5, are presented equivalent electrical circuit versus physical circuit arrangements of two planar secondary/sensing coils. Winding direction is assumed to begin in the positive terminal and end in the negative terminal, as shown.

In the sequel is demonstrated that, in the electrical circuit, the voltages induced by the time variations of the magnetic flux density normal to the XY plane, and having radial symmetry (\vec{B}(r, t)=B(r, t)ê_{z}, r=\sqrt{x²+y²}), are equal (FIG. 6 specifies the location of the (x, y)=(0,0) point.

More precisely, it is required to show that, neglecting PCB wire thickness, if the two secondary/sensing coils are a mirror of one another in such a way that if some point P(x_{A},y_{A}) belongs to the conductive wire in coil A and P(−x_{A},y_{A}) belongs to the conductive part of coil B, then v_{A}(t)=v_{B}(t) for all t.

With reference to FIG. 6, the proof is based on Faraday's law and proceeds turn by turn, beginning with coil B. A closed circuit is formed by completing one horizontal coil B turn tᵢ^{B} (in the XY plane) with a vertical conductor providing a measurement path tᵢ^{(measB)}, i=1, 2, . . . , N (where N is the number of turns of the coil). Faraday's law gives, since ϕᵢ^{(measB)})(t)=0 because the flux density is normal to the XY plane,

$${v}_{i}^{( measB )} = \frac{d ( {ϕ}_{i}^{( B )} ( t ) + {ϕ}_{i}^{( measB )} ( t ) )}{dt} = \frac{d {ϕ}_{i}^{( B )} ( t )}{dt}$$

The magnetic flux may be calculated by the following formula (voltage in the i-th coil B turn),

$${ϕ}_{i}^{( B )} ( t ) = {\int }_{x = {x}_{i}^{( m i n )}}^{{x}_{i}^{( m ax )}} {\int }_{y = {y}^{( m axB )} ( x )}^{{y}^{( ma xB )} ( x )} B ( \sqrt{{x}^{2} + {y}^{2}} ) dydx$$

With reference to FIG. 7, a more detailed view of coil A and B turns symmetry is shown.

Also, it will be shown that,

$${ϕ}_{i} ( t ) = {ϕ}_{i}^{( A )} ( t ) = {ϕ}_{i}^{( B )} ( t ) = {\int }_{x = {x}_{i}^{( m i n )}}^{{x}_{i}^{( m ax )}} {\int }_{y = {y}^{( m i nB )} ( x )}^{{y}^{( ma xB )} ( x )} B ( \sqrt{{x}^{2} + {y}^{2}} ) dydx$$

and therefore

$${v}_{i}^{( measA )} = {v}_{i}^{( measB )} = \frac{d {ϕ}_{i} ( t )}{dt} .$$

More precisely, the proof proceeds as follows:

$$\begin{matrix}{ϕ}_{i}^{( A )} ( t ) = {\int }_{x = - {x}_{i}^{( ma x )}}^{- {x}_{i}^{( m i n )}} {\int }_{y = {y}^{( m i n A )} ( x )}^{{y}^{( ma xA )} ( x )} B ( \sqrt{{x}^{2} + {y}^{2}} ) dydx \\ = {\int }_{x = - {x}_{i}^{( ma x )}}^{- {x}_{i}^{( m i n )}} {\int }_{y = {y}^{( m i n B )} ( - x )}^{{y}^{( ma xB )} ( - x )} B ( \sqrt{{x}^{2} + {y}^{2}} ) dydx \\ == - {\int }_{x = - {x}_{i}^{( m i n )}}^{- {x}_{i}^{( ma x )}} {\int }_{y = {y}^{( m i n B )} ( - x )}^{{y}^{( ma xB )} ( - x )} B ( \sqrt{{x}^{2} + {y}^{2}} ) dydx\end{matrix}$$

Now, make the change of variable specified by ξ=−x, dξ=−dx and ξ²=x². This gives

$${ϕ}_{i}^{( A )} ( t ) = {\int }_{ξ = {x}_{i}^{( m i n )}}^{{x}_{i}^{( m ax )}} {\int }_{y = {y}^{( m i nB )} ( ξ )}^{{y}^{( ma xB )} ( ξ )} B ( \sqrt{{ξ}^{2} + {y}^{2}} ) dyd ξ = {\int }_{x = {x}_{i}^{( m i n )}}^{{x}_{i}^{( m ax )}} {\int }_{y = {y}^{( m i nB )} ( x )}^{{y}^{( ma xB )} ( x )} B ( \sqrt{{x}^{2} + {y}^{2}} ) dydx = {ϕ}_{i}^{( B )} ( t )$$

When N turns in coils A and B are used, the total measured voltage is defined by:

$${v}_{A} ( t ) ≡ {v}_{tot}^{( measA )} ( t ) = {\sum }_{i = 1}^{N} {v}_{i}^{( measA )} ( t ) \\ {v}_{B} ( t ) ≡ {v}_{tot}^{( measB )} ( t ) = {\sum }_{i = 1}^{N} {v}_{i}^{( measB )} ( t )$$

Since vᵢ^{(measA)}=vᵢ^{(measB)}, i=1,2, . . . , N, it is clear that v_{A}(t)=v_{B}(t)=v(t).

With reference to FIG. 8, is shown one simple way for associating the two secondary/sensing coils in series and obtaining the total voltage 2v(t)=v_{A}(t)+v_{B}(t). In fact, since the three measurement conductor paths are parallel to the magnetic flux density \vec{B}(r, t)=B(r, t)ê_{z}, the induced voltage in them is zero and, in particular, Δv(t)=0. This allows for the recollection of 2v(t)=v_{A}(t)+v_{B}(t) between the inner points of coils A and B to be easily obtained by shunting the two points between which Δv(t) is defined.

A similar reasoning would show that in a clockwise-counterclockwise symmetry, the two coils would be in phase opposition and the total voltage would be zero (see FIG. 2).

### BRIEF DESCRIPTION OF THE DRAWINGS

For better understanding of the above, the prior art, and other features of the current invention, the related common or disclosed art and the preferred embodiments of the invention will be described in brief below with the reference to the illustrative drawings.

The illustrative drawings referred in this brief description should not be understood as being drawn to scale or to be complete relatively to any aspect, unless specifically noted.

In particular, the presented tables and charts are based on the simplifying assumption that each partial coil output is directly proportional to the percentage of its area non-covered by the partially metallized disk. For example, in FIG. 1 and FIG. 2, when θ=0°, windings A_{c}⁺ and Aₛ⁺ output a unit (normalized) voltage, and windings Bₛ⁻ and B_{c}⁻ output a null voltage.

FIG. 1—Prior art of schematic diagram of the primary/excitation coil, two pairs of secondary/sensing coils in a same layer of a PCB, and the 180° partially metallized disk-shaped target.

FIG. 2—Prior art of the planar disposition of the primary/excitation coils and two pairs of secondary/sensing coils in a same layer PCB.

FIG. 3—Prior art of the table of time-varying output voltages, Vₛᵢₙ and V_{cos}, as functions of the angle θ of a 180° partially metalized disk-shaped target.

FIG. 4—Prior art of time-varying output voltages Vₛᵢₙ and V_{cos}, as functions of the angle θ of a 180° partially metalized disk-shaped target.

FIG. 5—Two symmetric secondary/sensing coils, A and B, situated in the XY plane.

FIG. 6—One turn in coil B completed by a vertical wire (conductor) to get the voltage across it.

FIG. 7—Two symmetric turns, t₁^{A} in coil A and tᵢ^{B} in coil B, with equal voltages vᵢ^{(measA)}=vᵢ^{(measB)}.

FIG. 8—Measuring the sum of voltages vₜₒₜ^{(measA)} in coil A and vₜₒₜ^{(measB)} in coil B by shunting the two points between which Δv(t)=0 is defined.

FIG. 9—A preferred embodiment of the angular displacement decoder (exploded view).

FIG. 10—Schematic diagram of the primary/excitation coil and secondary/sensing coils in the multilayer PCB, in a particular embodiment of duets.

FIG. 11—Planar disposition of the primary/excitation coils and secondary/sensing coils in a multilayer PCB, in a particular embodiment of duets in each PCB layer.

FIG. 12—Table of time-varying output voltages, Vₛᵢₙ and V_{cos}, as functions of the angle θ of the 180° partially metalized disk-shaped target, in a particular embodiment of secondary/sensing coils in duets.

FIG. 13—Time-varying outputs voltages, Vₛᵢₙ and V_{cos}, as functions of the angle θ of the 180° partially metalized disk-shaped target, in a particular embodiment of secondary/sensing coils in duets.

FIG. 14—Schematic diagram of the primary/excitation coil and secondary/sensing coils in the multilayer PCB, in a particular embodiment of secondary/sensing coils in triplets in each PCB layer.

FIG. 15—Planar disposition of the primary/excitation coils and secondary/sensing coils in a multilayer PCB, in a particular embodiment of triplets in each PCB layer.

FIG. 16—Table of time-varying output voltages, Vₛᵢₙ and V_{cos}, as functions of the angle θ of the 180° partially metalized disk-shaped target, in a particular embodiment of secondary/sensing coils in triplets in each PCB layer.

FIG. 17—Time-varying output voltages, Vₛᵢₙ and V_{cos}, as functions of the angle θ of the 180° partially metalized disk-shaped target, in a particular embodiment of secondary/sensing coils in triplets in each PCB layer.

FIG. 18—Schematic diagram of the primary/excitation coil and secondary/sensing coils in the multilayer PCB, in a particular embodiment of secondary/sensing coils in quartets in each PCB layer.

FIG. 19—Planar disposition of the primary/excitation coils and secondary/sensing coils in a multilayer PCB, in a particular embodiment of quartets in each PCB layer.

FIG. 20—Table of time-varying output voltages, Vₛᵢₙ and V_{cos}, as functions of the angle θ of the partially metalized disk-shaped target, in a particular embodiment of secondary/sensing coils in quartets.

FIG. 21—Time-varying output voltages, Vₛᵢₙ and V_{cos}, as functions of the angle θ of the 180° partially metalized disk-shaped target, in a particular embodiment of secondary/sensing coils in quartets in each PCB layer.

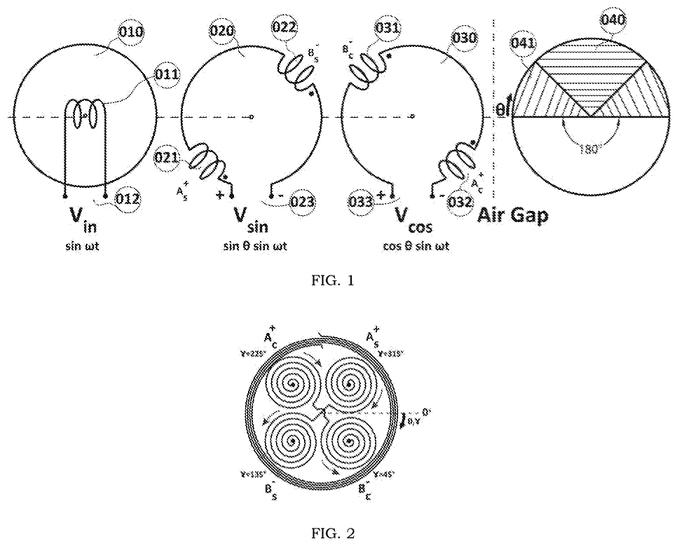

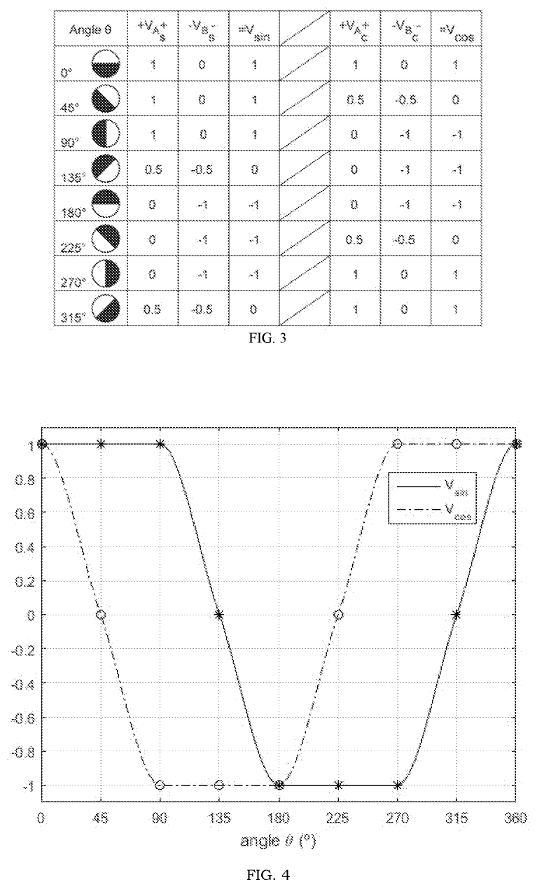

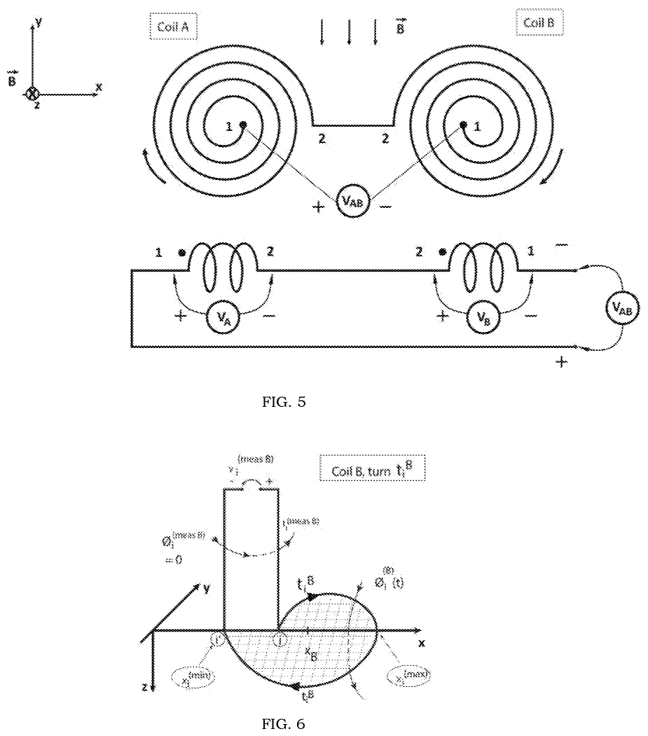

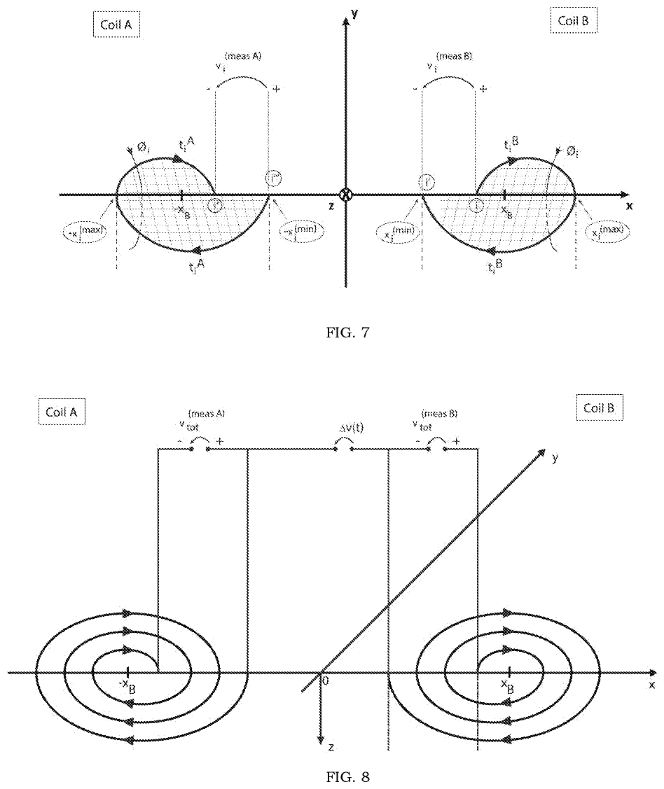

### DETAILED DESCRIPTION

Now, detailed descriptions of various embodiments will be made, which are enlightened by examples in the enclosed drawings.

The several embodiments that are discussed herein are intended to cover variants and/or equivalents which may be included within the same scope as defined by the enclosed claims.

Moreover, plentiful specific details are defined in order to provide a careful understanding of the embodiments, thus they may be experienced without one or some of those specific details. Also, for simplicity, well-known methods and/or processes of the art are not described.

The used terms and definitions, including the technical and scientific ones used in several embodiments, even if not mentioned in some particular embodiments, are considered to be valid along all the embodiments that are part of this invention.

Also, unless defined otherwise, the terms and definitions used herein have the same meaning as commonly understood by one ordinary skilled in the art of this invention.

The terms and definitions defined in commonly used dictionaries, should be interpreted as have a meaning that is coherent in the context of the important art and should not be interpreted in an idealized or exceedingly formal sense unless expressly defined herein in a different way.

The present invention provides a device for decoding an angular displacement of a rotating partially metallized disk-shaped target with improved sensitivity, accuracy, precision, linearity, and resolution of the inductive angular displacement decoder device which utilizes innovative multilayer planar coils arrangement and interconnection, by using multilayer printed circuit boards (PCB), in a form of a cylindrical stack.

The present invention provides an angular displacement decoder comprising multilayer planar coils, as a designated stator set, as comprising a planar primary coil, as the source of magnetic excitation, and a plurality of planar secondary coils, as sensing elements, distributed by a plurality of layers of a multilayer printed circuit board (PCB).

In several embodiments, the present invention provides a standard model for planar coil cylindrical stack assembly layouts, by using multilayer PCBs, to implement resolvers and synchro devices that can be used for decoding angular displacements.

The angular displacement decoder devices of the present invention can operate even in the case of small diameters of rotating conductive targets, for example, in the range of diameters as low as 10 mm, and/or in conditions of higher lengths of air gaps between rotating conductive targets and the stator, higher than 10 mm, with high sensitivity, accuracy, precision, linearity, and resolution, therefore obtaining measurable time-varying differential output voltages, which exempt the use of complex, expensive, and energy-consuming analog and/or digital conditioning and/or processing circuits, which can be disadvantageous in power-constrained and/or mass-market applications. These advantages are specially relevant for most of the field applications, when the rotating conductive targets have small diameters and the costs of multilayer PCBs are negligible when compared with the expensive costs of the complex analog and/or digital conditioning and/or processing circuits, even undervaluing the benefits of reducing the energy-consumptions of the whole device, relatively to other single or double-layered PCB implementations currently known in the art. For a better understanding of the present invention, together with other and further objects, advantages and capabilities thereof, reference is made to the following disclosure and appended claims taken in conjunction with the above-described drawings.

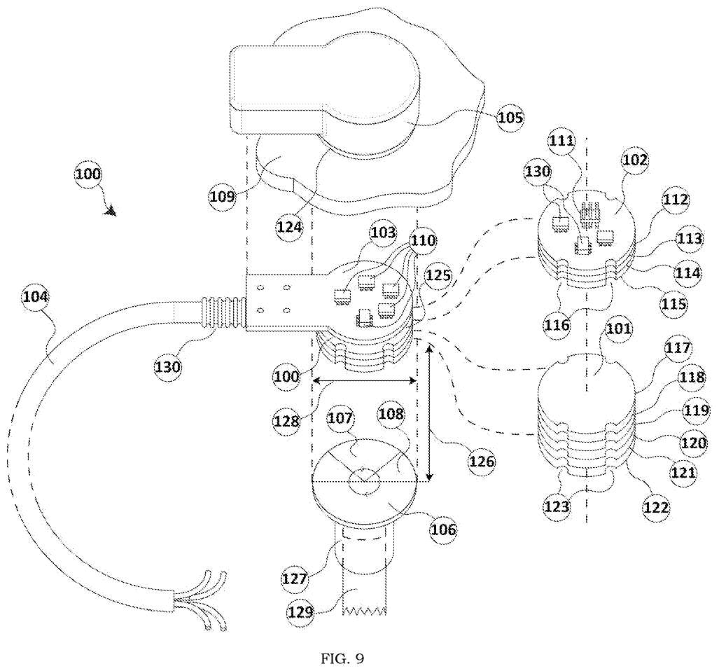

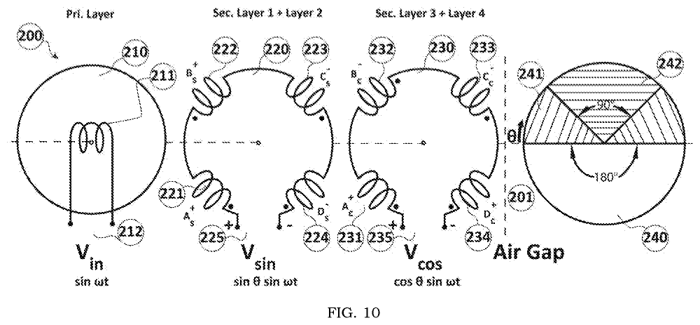

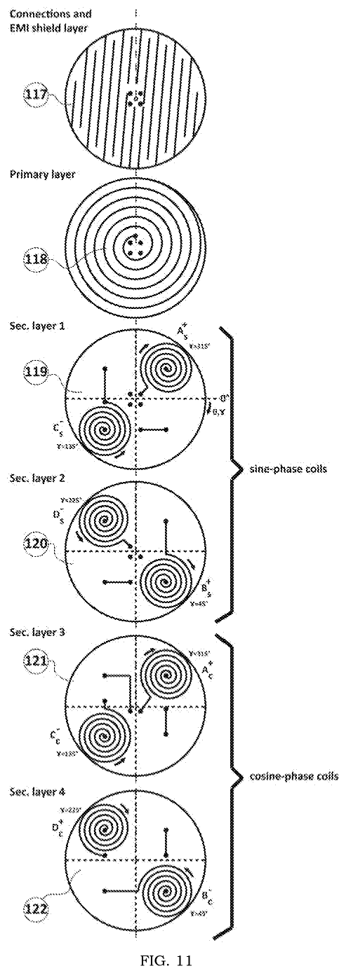

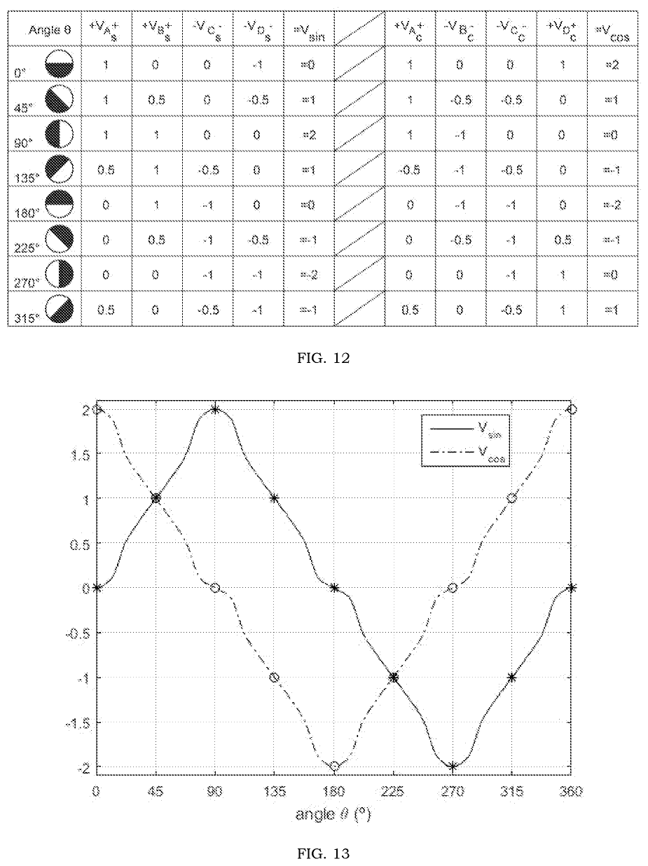

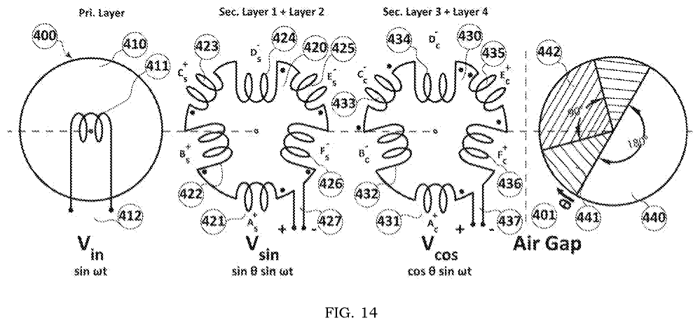

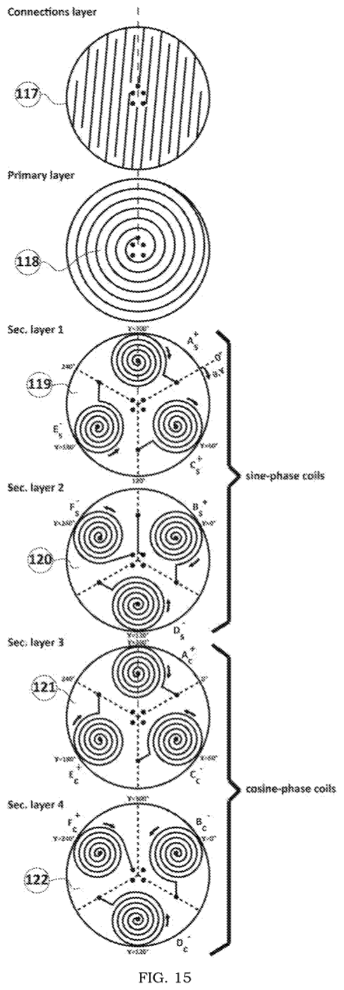

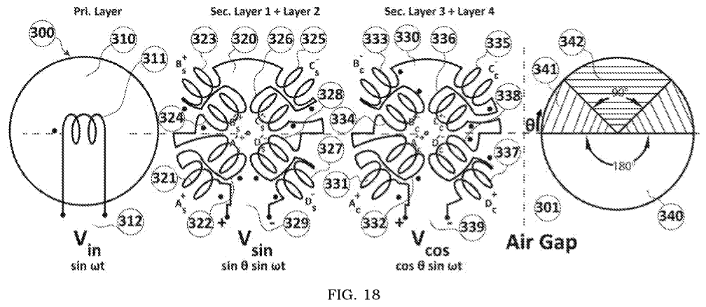

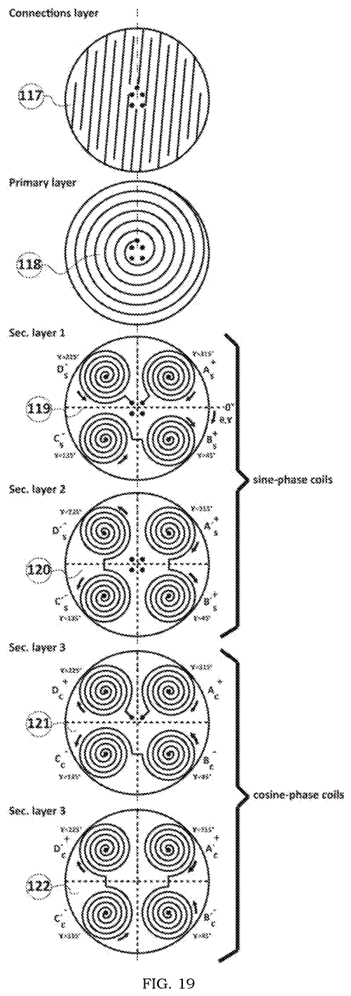

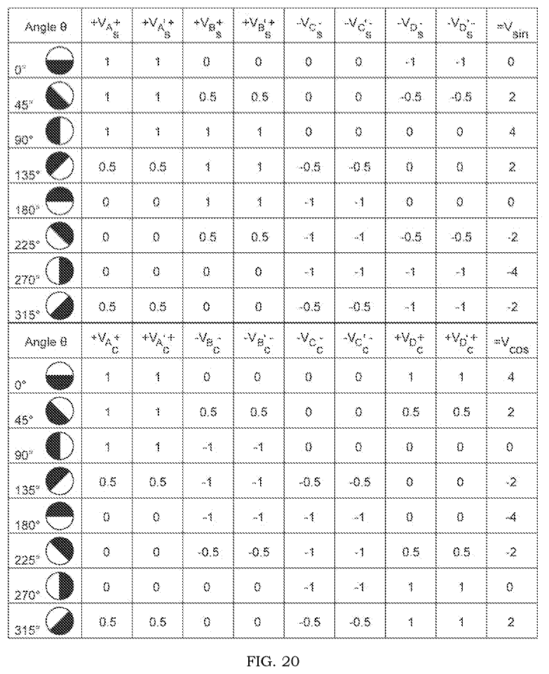

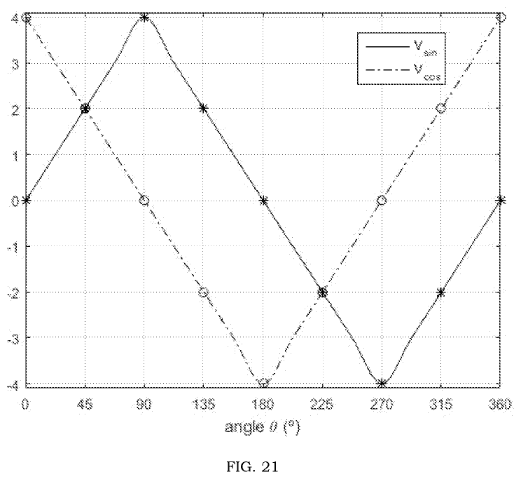

With reference to FIG. 9, FIG. 10, FIG. 11, FIG. 12, FIG. 13, FIG. 14, FIG. 15, FIG. 16, FIG. 18, FIG. 19, FIG. 20 and FIG. 21 is shown an angular displacement decoder and a method of decoding the angles, in accordance with several embodiments of the invention.

With reference to FIG. 9, in a main preferred embodiment of the present invention, as an angular displacement decoder 100 and a method of decoding the angles, as comprising a designated rotor, a rotating conductive target, as a partially metallized disk-shaped target 106, a designated stator set, as a cylindrical stack 101, 102, and 103, namely including a planar primary coil, as the source of excitation, a plurality of planar secondary coils, as sensing elements, disposed and interconnected in innovative manner, a plurality of electromagnetic interference (EMI) shielding layers, distributed by a plurality of layers of multilayer printed circuit boards (PCB), a shielded multi-conductor cable 104 used for bidirectional transmission of standardized digital data or analog data and for powering the device, that includes a sleeve sheath 130 to preserve the mechanical integrity of the cable, and a thermoplastic case 105, that encapsulates all the parts of the device and is a mean of fitting the device to a mechanical static part 109 of the field application system, through a mechanical mean, for example a bi-adhesive tape layer 124, or by using screws (not shown).

The rotating conductive target, as a partially metallized disk-shaped target 106, may be coupled by a gearing mechanism 127, or by another similar means, to a rotating body shaft 129, that is driven in rotation along its axis of revolution, and can be part of a field application system that typifies the angular position-decoding systems for the computation of the displacement angles of rotating actuators in controlled or regulated mechanisms, and/or in metering devices that can include a rotating indicator gauge that represents the quantity of a commodity that is being consumed. As an example of such application systems, the measuring of displacement angles of the azimuth and/or altitude of a dual-axis solar tracker system in photovoltaic solar systems, and the rotating indicator gauge that can represent the volume of water that is being consumed by each turn of revolution, in a water meter.

The rotating conductive target, as a partially metallized disk-shaped target 106, can include a multitude of center angles of the partially metalized disk-shaped target from 90° to 270°, exemplified as 107 (90°) and 108 (180°) while maintaining the adequate performance, namely high sensitivity, accuracy, precision, linearity, and resolution.

The designated stator set part 101 comprises a planar connection and EMI shielding layer 117, namely as mean of interconnecting the stator set part 101 to the stator set part 102, the primary/excitation coil layer 118, the planar secondary/sensing coils in layers 119, 120, 121, and 122, connected and disposed in innovative manner, as sensing elements, through the use of vias, half-vias, pads, and/or conductive tracks, in the PCB layer 123. The particular preferred embodiments, as described later in detail, will be based in the different forms of the planar secondary/sensing coils as duets, triplets, quartets, or higher forms, for example, as hexets, as ways of obtaining different sensitivities, accuracies, precisions, linearities, and resolutions.

In preferred embodiments, and in particularly in the designed stator set 101, shall be used the method for construction of the angular displacement decoder, of a rotating conductive target, as a partially metallized disk-shaped target, through the deployment of the following five steps: (i) choosing the desired number of phases of time-varying output voltages; (ii) choosing the angle shifting between the phases of the time-varying output voltages; (iii) choosing the factor of sensitivity (FS) of the device by computing the number of planar secondary/sensing coils (iv) disposing the planar secondary/sensing coils, distributed by the layers of the multilayer printed circuit board (PCB) and in accordance with individual coils polarity voltages versus the relative position in the trigonometric circle to obtain the desired time-varying output voltages by each angular position; (v) arrangement of individual physical circuit of planar secondary/sensing coils addressed through obtaining the maximal symmetry relatively to the axis of revolution and the minimal use of vias, half-vias, pads, and/or conductive tracks, among the PCB layers.

The designated stator set part 102 comprises planar connections and an EMI shielding layer 115, a mean of interconnecting the stator set part 102 to the stator set part 101, an EMI shielding layer 114, a planar ground plane layer 113, a first electronic circuit layer 112, symbolically represented by electronic components 130, by the half-vias 116, and by a modular male connector 111, for a standard connection to a system application.

The EMI shielding layers, namely 114, 115, and 117 have the function of allowing the compliance with legal and regulatory EMI requirements and of reducing the susceptibility to electromagnetic and/or magnetic perturbations to emissions by external sources, such as random from the electromagnetic environment, or intentional with the purpose of fraud, or to emissions by the device as the own source for the electromagnetic interference.

The designated stator set part 103, comprises a modular female connector, facing down, not shown, and a second electronic circuit layer 125, not shown, as a means of interconnecting the stator set part 103 to the stator set part 102, a third electronic circuit layer 103, symbolically represented by electronic components 110, for a standard connection in a system application.

With reference to FIG. 9 and FIG. 11, in this particular embodiment of the present invention, the planar primary/excitation coil is disposed in one determined layer 118 of a multilayer PCB, with the planar secondary/sensing coils arranged in duets (not in pairs, because they are not directly interconnected between them), all disposed symmetrically relatively to the axis of revolution (one rotated 180° relatively to the other), where each two duets of each phase of output voltages are disposed in one same layer of multilayer PCB, one phase of output voltage in layers 119 and 120, another phase of output voltage in layers 121 and 122, in a form of a cylindrical stack 101, and the partially metallized disk-shaped target 106 that rotates around the same axis of revolution, is disposed with an air gap 126 at a determined distance from the stator set.

The planar primary/excitation coil 118 is powered by a periodic time-varying wave-generator (not shown), with a determined waveform, such as a square wave or a sinusoidal wave. As a consequence the time-varying output voltages from the planar secondary/sensing coils are immediately present, as will be described in detail later.

The mentioned rotor 106 and the mentioned stator set 101, 102, and 103 are aligned perpendicularly with the same axis of revolution inside of the same delimitation line of the circumference of the entire decoder set, shaped as a cylindrical stack 100, formed by the different layers of the multilayer PCBs, with diameter 128.

The rotor 106 comprises a rotating conductive target, as a partially metallized disk-shaped target shaped as a circular sector from 90° to 270°, exemplified as 107 (90°) and 108 (180°), so as to cause variations in induction coupling (M) between the planar primary/excitation coil 118 and the planar secondary/sensing coils 119, 120, 121, and 122 due to Foucault currents effects, as a function of the overlap in stator set, in response to its current rotating position, with underlying variations of the induced time-varying differential voltages in planar secondary/sensing coils 119, 120, 121, and 122.

In accordance with the common art of ratiometric measurement approach, two planar secondary/sensing coils can be interconnected to one another in series, and in phase opposition, relatively to one another, and the innermost terminals of each secondary coils may be used to measure the differential output voltage, that is function of the angular position of the rotating conductive target, as shown in FIG. 2. This approach is directly valid for two planar secondary/sensing coils, but cannot be directly used here, because instead of two planar secondary/sensing coils of the common art, there are eight planar secondary/sensing coils, such as four planar secondary/sensing coils by each coil set of two duets, disposed in different layers that may lead to generate offset voltages among the different planar secondary/sensing coils, due the different distances from the primary/excitation coil, and underlying induction couplings (M). As known, it is necessary to generate the time-varying output voltages 90° phase-shifted (e.g. sinθ and sin(θ+90°)), between the two coil sets of two duets.

Therefore, with reference to FIG. 10 and FIG. 11, using the same reasoning of ratiometric measurement approach, by disposing the planar secondary/sensing coils in order to sense the desired coil output voltages with negative or positive magnitudes in a series circuit, in accordance with each relative quadrant where each planar secondary/sensing coils 221, 222, 223, 224, 231, 232, 233, and 234 pertains on the trigonometric circle, and connecting them in a way that final summation of the unitary contributions of all planar secondary/sensing equal to zero in the absence of the partially metallized disk-shaped target, a similar and equally usable result can be obtained.

As following, it is demonstrated that the physical and electrical arrangements of the primary/excitation coil 211 and of the secondary/sensing coils 221, 222, 223, 224, 231, 232, 233, and 234 lead to the cancelation of the undesired voltage offsets among the different planar secondary/sensing coils.

Therefore, considering the ratiometric measurement approach, and implementing the analysis of the electric circuital meshes 220 and 230, in the condition of not-influence of the partially metallized disk-shaped target, whatever the value of the excitation source sin(ωt) 212, the value of Vₛᵢₙ 225 and V_{cos} 235 should be equal to zero.

However, as mentioned, the different distances of the secondary/sensing coils, in the different layers of the PCB, relatively to the primary/excitation coil, imply the obtaining of offset voltages Δvₛ between the secondary/sensing coils in layer 119 and layer 120, in the electric circuit of Vₛᵢₙ 225, and offset voltages ΔV_{c} between the secondary/sensing coils in layer 121 and layer 122, in the circuit of V_{cos} 235. These offset voltages are canceled if the secondary/sensing coils are arranged in the innovative way described in this patent, as is shown next.

So, firstly computing Vₛᵢₙ 225 by using the mesh's law, and considering the offsets ΔVₛₖ (the offset voltages between the layers 119 and 120), the following expression is obtained:

Vₛᵢₙ=V_{A}_{ₛ}_{⁺}−V_{C}_{ₛ}_{^{−}}+(V_{B}_{ₛ}_{⁺}+ΔV_{B}_{ₛ}_{⁺})−(V_{D}_{ₛ}_{^{−}}+ΔV_{D}_{ₛ}_{^{−}}) (i).

As {B, D} are in same layer, invoking circular symmetry, ΔV_{B}_{ₛ}_{⁺}=ΔV_{D}_{ₛ}_{^{−}}=ΔVₛ and V_{B}_{ₛ}_{⁺}=V_{D}_{ₛ}_{^{−}}. Furthermore, since {A, C} are in the same layer, V_{A}_{ₛ}_{⁺}=V_{C}_{ₛ}_{^{−}}. Using these equalities in (i) leads, as requested, to

Vₛᵢₙ=0.

A similar reasoning can be used to prove that V_{cos}=0.

From the above results, it may be concluded that the innovative arrangement of the circuits of secondary/sensing coils and of PCB layers preserves the principle of the ratiometric measurement approach, resulting in a completely balanced electric circuit as it was positioned in the same layer of the PCB.

Again with reference to FIG. 10 and FIG. 11, a first coil set of two duets 220, is disposed in two different layers of the multilayer PCB 119 and 120, interconnected in such way, by including a series circuit of two clockwise secondary/sensing coils 221 and 222 and two counterclockwise secondary/sensing coils 223 and 224, to generate one-phase of time-varying output voltage designated Vₛᵢₙ 225, and a second coil set of two duets 230, disposed in another two different layers of the multilayer PCB 121 and 122, interconnected in another determined way, by including a series circuit of one clockwise secondary/sensing coil 231, two counterclockwise secondary/sensing coils 232 and 233, an one more clockwise secondary/sensing coil 234, to generate another phase of time-varying output voltage designated V_{cos} 235, leading to obtain a resolver device.

The first coil set 220 of time-varying output voltage designated Vₛᵢₙ 225 is physically constructed through the secondary/sensing coils layers 119, and 120, with one voltage pole in the outer turn terminal of clockwise secondary/sensing coil Aₛ⁺ on PCB layer 119, interconnected by the use of vias, pads, and/or conductive tracks with the connections layer 117, that leads the time-varying output voltage designated Vₛᵢₙ 225 to standardization electronic circuits on layers 102 and 103, and the inner terminal of secondary/sensing coil Aₛ⁺ on PCB layer 119, interconnected by the use of vias, pads, and/or conductive tracks with the outer terminal of clockwise secondary/sensing coil Bₛ⁺ on PCB layer 120, and the inner terminal interconnected by the use of vias, pads, and/or conductive tracks with the inner terminal of counterclockwise secondary/sensing coil Cₛ⁻ on PCB layer 119, and the outer terminal interconnected by the use of vias, pads, and/or conductive tracks with the inner terminal of counterclockwise secondary/sensing coil Dₛ⁻ on PCB layer 120, and the outer terminal interconnected by the use of vias, pads, and/or conductive tracks with the connections layer 117, that leads the another voltage pole of time-varying output voltage designated Vₛᵢₙ 225 to standardization electronic circuits on layers 102 and 103.

The second coil set 230 of time-varying output voltage designated V_{cos} 235 is physically constructed through the secondary/sensing coils layers 121, and 122, with one voltage pole in the outer turn terminal of clockwise secondary/sensing coil A_{c}⁺ on PCB layer 121, interconnected by the use of vias, pads, and/or conductive tracks with the connections layer 117, that leads the time-varying output voltage designated V_{cos} 235 to standardization electronic circuits on layers 102 and 103, and the inner terminal of secondary/sensing coil A_{c}⁺ on PCB layer 121, interconnected by the use of vias, pads, and/or conductive tracks with the inner terminal of counterclockwise secondary/sensing coil B_{c}⁻ on PCB layer 122, and the outer terminal interconnected by the use of vias, pads, and/or conductive tracks with the inner terminal of counterclockwise secondary/sensing coil C_{c}^{- on PCB layer 121, and the outer terminal interconnected by the use of vias, pads, and/or conductive tracks with the outer terminal of clockwise secondary/sensing coil D}_{c}⁺ on PCB layer 122, and the inner terminal interconnected by the use of vias, pads, and/or conductive tracks with the connections layer 117, that leads the another voltage pole of time-varying output voltage designated V_{cos} 235 to standardization electronic circuits on layers 102 and 103.

The first coil set 220 and the second coil set 230 generate the two-phase of time-varying output voltages, designated Vₛᵢₙ 225 and designated V_{cos} 235, as characteristic of a resolver device, which in this case are arranged in such a manner that the time-varying output voltages are 90° phase-shifted (e.g. sinθ, and sin(θ+90°)).

In a particular embodiment, the primary/excitation coil 211 comprises five turns and the secondary/sensing coils 221, 222, 223, 224, 231, 232, 233, and 234 comprise six turns. Thus, the number of turns of the primary/excitation coil and of the secondary/sensing coils may be adjusted to particular variants.

With reference to FIG. 10, FIG. 12 and FIG. 13, are presented, in a form of table, and of chart, the two-phases of time-varying output voltages, designated Vₛᵢₙ 225 and designated V_{cos} 235, as a function of the rotation angle of the partially metallized disk-shaped target.

According to the present invention and the current embodiment, the rotation displacement decoder device has been described to have two-phases of time-varying output voltages as characteristically generated by a resolver, thus it can also be built to have three-phases of time-varying output voltages as characteristically generated by a synchro device, which in such case, should be designed three sets of planar secondary/sensing coils, arranged in such a manner that the time-varying output voltages are 120° phase-shifted (e.g. sinθ, sin(θ+120°) and sin(θ+240°)). The same reasoning is valid to build multi-phase devices of time-varying output voltages.

With reference to FIG. 9 and FIG. 15, in another embodiment object of the present invention providing an angular displacement decoder 100, a resolver device, characterized by having two phases of time-varying output voltages, by having a factor of sensitivity (FS) of three, and by having an angle shifting between the phases time-varying output voltages of 120°. It also comprises multilayer planar coils, which includes a designated rotor 106, as the rotating conductive target, as a partially metallized disk-shaped target, from 90° to 270°, exemplified as 107 (90°) and 108 (180°), and a designated stator set, as a cylindrical stack 101, 102, and 103, as comprising a planar primary coil 118, as the source of excitation, and a plurality of planar secondary coils, as sensing elements, disposed and connected in innovative manner, distributed by a plurality of layers of a multilayer printed circuit board (PCB) 119, 120, 121, and 122, as will be disclosed in detail later.

The planar primary/excitation coil is disposed in one determined layer of multilayer PCB 118, with the planar secondary/sensing coils disposed in triplets by each layer, with each one planar secondary/sensing coil rotated 120° relatively to the axis of revolution with each another, where the two triplets in the layers 119 plus 120 generate one phase output voltage, and the another two triplets in the layers 121 plus 122 generate another phase output voltage. In accordance with the common art of ratiometric measurement approach, two planar secondary/sensing coils can be connected to one another in series, and in phase opposition, relatively to one another, and the innermost terminals of each secondary coils may be used to measure the output differential voltage, that is function of the angular position of the rotating conductive target, as shown in FIG. 2. This approach is directly valid for two planar secondary/sensing coils, but cannot be directly used here, because instead of two planar secondary/sensing coils of the common art, there are twelve planar secondary/sensing coils, such as six planar secondary/sensing coils by each coil set of two triplets, disposed in different layers that may lead to generate voltage offsets among the different planar secondary/sensing coils due the different distances from the primary/excitation coil, and underlying induction couplings (M). Furthermore, it is necessary to generate the output time-varying voltages 120° phase-shifted (e.g. sinθ and sin(θ+120°) between the two coil sets of two triplets.

Therefore, with reference to FIG. 14 and FIG. 15, using the same reasoning of ratiometric measurement approach, by disposing the planar secondary/sensing coils in order to sense the desired coil output voltages with negative or positive magnitudes in a series circuit, in accordance with each relative quadrant where each planar secondary/sensing coils 421, 422, 423, 424, 425, 426, 431, 432, 433, 434, 435 and 436 pertains on the trigonometric circle, and connecting them in a way that final summation of the unitary contributions of all planar secondary/sensing coils in each phase is small in the absence of the partially metallized disk-shaped target, a similar and equally usable result can be obtained.

Next, it is demonstrated that the physical and electrical arrangements of the primary/excitation coil 411 and of the secondary/sensing coils 421, 422, 423, 424, 425, 426, 431, 432, 433, 434, 435 and 436 lead to a partial cancelation of the undesired offset voltages among the different planar secondary/sensing coils when the partially metalized disk-shaped target is absent.

Considering the ratiometric measurement approach, and implementing the analysis of the electric circuital meshes 420 and 430, in the condition of not-influence of the partially metallized disk-shaped target, whatever the value of the excitation source sin cot 412, the value of Vₛᵢₙ 427 and V_{cos} 437 should be small.

As mentioned, the different distances of the secondary/sensing coils, in the different layers of the PCB, relatively to the primary/excitation coil, imply the obtaining of offset voltages ΔVₛ between the secondary/sensing coils in layer 119 and layer 120, in the electric circuit of Vₛᵢₙ 427, and offset voltages ΔV_{c} between the secondary/sensing coils in layer 121 and layer 122, in the circuit of V_{cos} 437. These offset voltages are partially canceled if the secondary/sensing coils are arranged in the innovative way described in this patent, as is shown next.

So, firstly computing Vₛᵢₙ 427, by using the mesh's law, by considering ΔVₛₖ the voltage offsets between the layers 119 and 120, in the circuit loop 420, the following expression is obtained:

Vₛᵢₙ=V_{A}_{ₛ}_{⁺}+V_{C}_{ₛ}_{⁺}−V_{E}_{ₛ}_{^{−}}+(V_{B}_{ₛ}_{⁺}+ΔV_{B}_{ₛ}_{⁺})−(V_{D}_{ₛ}_{^{−}}+ΔV_{D}_{ₛ}_{^{−}})−(V_{F}_{ₛ}_{^{−}}+ΔV_{F}_{ₛ}_{^{−}}) (ii).

As {B, D, F} are in same layer and have the same number of turns, invoking circular symmetry, ΔV_{B}_{ₛ}_{⁺}=ΔV_{D}_{ₛ}_{^{−}}=ΔV_{F}_{ₛ}_{^{−}}=ΔVₛ and V_{B}_{ₛ}_{⁺}=V_{D}_{ₛ}_{^{−}}=V_{F}_{ₛ}_{^{−}}. Furthermore, since {A, C, E} are in the same layer, V_{A}_{ₛ}_{⁺}=V_{C}_{ₛ}_{⁺}=V_{E}_{ₛ}_{^{−}}. Furthermore, since ΔVₛ denotes the unique interlayer offset voltage, V_{A}_{ₛ}_{⁺}=V_{C}_{ₛ}_{⁺}=V_{E}_{ₛ}_{^{−}}=V_{B}_{ₛ}_{⁺}=V_{D}_{ₛ}_{^{−}}=V_{F}_{ₛ}_{^{−}}. Using these equalities in (ii) leads to

Vₛᵢₙ=−ΔVₛ

A similar reasoning can be used to prove that V_{cos} contains only one offset voltage ΔV_{c}.

From the above results, it may be concluded that the innovative arrangement of the circuits of secondary/sensing coils and of PCB layers lead to a good approximation of the principle of the ratiometric measurement approach, resulting in a partially balanced electric circuit where two offset voltages cancel, almost as in the case where all windings are positioned in the same layer of the PCB, as ideally desired, with the advantage of producing stronger signals, with less noise.

Again with reference to FIG. 14 and FIG. 15, a first coil set of two triplets 420, is disposed in two different layers of the multilayer PCB 119 and 120, connected in such way, by including a series circuit of three clockwise secondary/sensing coils 421, 422 and 423 and three counterclockwise secondary/sensing coils 424, 425 and 426, to generate one-phase of time-varying output voltage designated Vₛᵢₙ 427, and a second coil set of two triplets 430, disposed in another two different layers of the multilayer PCB 121 and 122, connected in another determined way, by including a series circuit of one clockwise secondary/sensing coil 431, three counterclockwise secondary/sensing coils 432, 433, and 434, an two more clockwise secondary/sensing coils 435 and 436, to generate another-phase of time-varying output voltage designated V_{cos} 437, leading to obtain a resolver device.

The first coil set 420 of time-varying output voltage designated Vₛᵢₙ 427 is physically constructed through the secondary/sensing coils in layers 119, and 120, with one voltage pole in the inner terminal of clockwise secondary/sensing coil Aₛ⁺ in PCB layer 119, interconnected by the use of vias, pads, and/or conductive tracks with the connections layer 117, that leads the time-varying output voltage designated Vₛᵢₙ 427 to customizable electronic circuits on layers 102 and 103, and the outer terminal of secondary/sensing coil Aₛ⁺ in PCB layer 119, is interconnected by the use of vias, pads, and/or conductive tracks to the inner terminal of clockwise secondary/sensing coil Bₛ⁺ in PCB layer 120, that coil having its outer terminal interconnected by the use of vias, pads, and/or conductive tracks with the inner terminal of clockwise secondary/sensing coil Cₛ⁺ in PCB layer 119, that coil having its outer terminal interconnected by the use of vias, pads, and/or conductive tracks to the inner terminal of counterclockwise secondary/sensing coil Dₛ⁻ in PCB layer 120, with its outer terminal interconnected by the use of vias, pads, and/or conductive tracks with the inner terminal of counterclockwise secondary/sensing coil Eₛ⁻ in PCB layer 119, that coil having its outer terminal interconnected by the use of vias, pads, and/or conductive tracks to the inner terminal of counterclockwise secondary/sensing coil Fₛ_{_{−}} in PCB layer 120, that coil having its outer terminal interconnected by the use of vias, pads, and/or conductive tracks to the connections layer 117, that leads to the another voltage pole of time-varying output voltage designated Vₛᵢₙ 427 to standard customizable electronic circuits on layers 102 and 103.

The second coil set 430 of time-varying output voltage designated V_{cos} 437 is physically constructed through the secondary/sensing coils layers 121, and 122, with one voltage pole in the inner terminal of clockwise secondary/sensing coil A_{c}⁺ in PCB layer 121, being interconnected by the use of vias, pads, and/or conductive tracks to the connections layer 117, that leads the time-varying output voltage designated V_{cos} 437 to standard customizable electronic circuits on layers 102 and 103, and the outer terminal of secondary/sensing coil A_{c}⁺ in PCB layer 121, is interconnected by the use of vias, pads, and/or conductive tracks to the inner terminal of counterclockwise secondary/sensing coil B_{c}⁻ in PCB layer 122, that coil having the outer terminal interconnected by the use of vias, pads, and/or conductive tracks to the inner terminal of counterclockwise secondary/sensing coil C_{c}⁻ in PCB layer 121, which outer terminal is interconnected by the use of vias, pads, and/or conductive tracks to the inner terminal of the counterclockwise secondary/sensing coil D_{c}⁻ in PCB layer 122, which outer terminal is interconnected by the use of vias, pads, and/or conductive tracks to the inner terminal of clockwise secondary/sensing coil E_{c}⁺ in PCB layer 121, which outer terminal is interconnected by the use of vias, pads, and/or conductive tracks to the inner terminal of clockwise secondary/sensing coil F_{c}⁺ in PCB layer 122, which outer terminal is interconnected by the use of vias, pads, and/or conductive tracks to the connections layer 117, that leads the another voltage pole of time-varying output voltage designated V_{cos} 437 to customizable standard electronic circuits on layers 102 and 103.

The first coil set 420 and the second coil set 430 generate the two-phases of time-varying output voltages, designated Vₛᵢₙ 427 and V_{cos} 437, as characteristic of a resolver device, which in this case are arranged in such a manner that the time-varying output voltages are 120° phase-shifted (e.g. sinθ, and sin(θ+120°)).

In a particular embodiment, the primary/excitation coil 411 comprises five turns and the secondary/sensing coils 421, 422, 423, 424, 425, 426, 431, 432, 433, 434, 435 and 436 comprise six turns. The number of turns of the primary/excitation coil and of the secondary/sensing coils may be adjusted to particular variants of the embodiment.

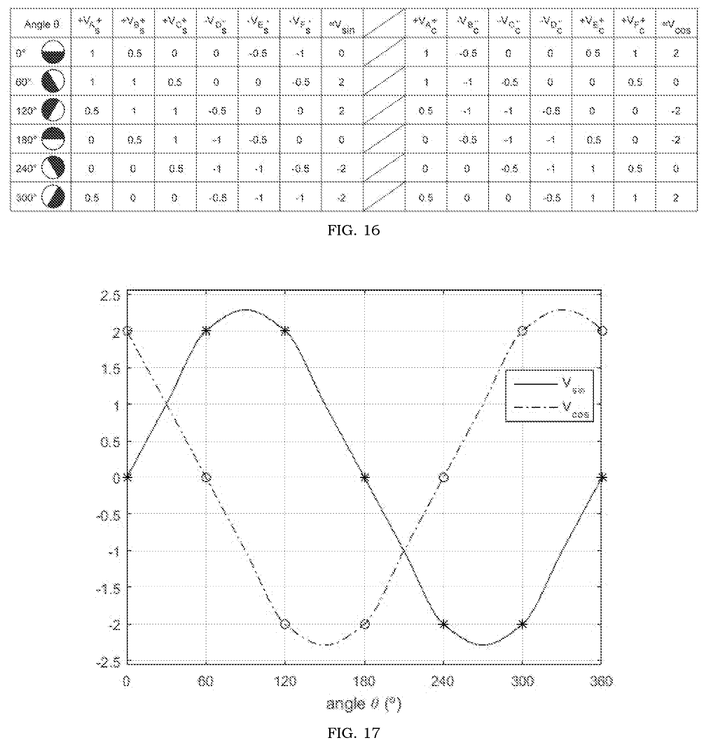

With reference to FIG. 16 and FIG. 17, are presented, in a form of table, and of chart, the two-phases of time-varying output voltages, designated Vₛᵢₙ 427 and V_{cos} 437 as functions of the rotation angle θ of the partially metalized disk-shaped target of one embodiment which schematic is represented in FIG. 14. According to the present invention and the current embodiment, the rotation displacement decoder device has been described to have two-phases of time-varying output voltages as characteristically generated by a resolver, thus it can also be built to have three-phases of time-varying output voltages as characteristically generated by a synchro device, which in such case, should be designed three sets of planar secondary/sensing coils, arranged in such a manner that the time-varying output voltages are 120° phase-shifted (e.g. sinθ, sin(θ+120°, and sin(θ+240°). The same reasoning is valid to build multi-phase devices of time-varying output voltages.

With reference to FIG. 9, FIG. 18 and FIG. 19, in another embodiment which is object of the present invention providing an angular displacement decoder 100, a resolver device, characterized by having two phases of time-varying output voltages, by having a factor of sensitivity (FS) of four, and by having an angle shifting between the phases of time-varying output voltages of 90°, and comprising multilayer planar coils, which includes a designated rotor 106, as the rotating conductive target, as a partially metallized disk-shaped target, from 90° to 270°, exemplified as 107 (90°) and 108 (180°), and a designated stator set, as a cylindrical stack 101, 102, and 103, as comprising a planar primary coil 118, as the source of excitation, and a plurality of planar secondary coils, as sensing elements, connected and disposed in innovative manner, distributed by a plurality of layers of a multilayer printed circuit board (PCB) 119, 120, 121, and 122, as will be disclosed in detail later.

The planar primary/excitation coil is disposed in one determined layer 118 of multilayer PCB, with the planar secondary/sensing coils disposed in quartets in each layer, with each one planar secondary/sensing coil rotated 90° relatively the axis of revolution with each another, where the two quartets in the layers 119 plus 120 generate one phase output voltage, and the another two quartets in the layers 121 plus 122 generate another phase of output voltage, as a form of a cylindrical stack 101, and the partially metallized disk-shaped target 106 that rotates around the same axis of revolution, disposed with an air gap at determined distance from the stator set 126.

The planar primary/excitation coil 118 is powered by a periodic time-varying wave-generator (not shown), with a determined waveform, such as a square wave or a sinusoidal wave, whereby the time-varying output voltages from the planar secondary/sensing coils are immediately present, as will be described in detail later.

The mentioned rotor 106 and the mentioned stator set 101, 102, and 103 are aligned perpendicularly with the same axis of revolution inside of the same delimitation line of the circumference of the entire decoder set, shaped as a cylindrical stack 100, formed by the different layers of the multilayer PCBs, with diameter 128.

The rotor 106 comprises a rotating conductive target, as a partially metallized disk-shaped target 106, where the conductive part is a circular sector with an angle that may vary from 90° to 270°, so as to cause variations in induction coupling (M) between the planar primary/excitation coil 118 and the planar secondary/sensing coils 119, 120, 121, and 122 due to Foucault currents effects, as a function of the overlap in stator set, in response to its current rotating position, with underlying variations of the induced time-varying differential voltages in planar secondary/sensing coils 119, 120, 121, and 122. In accordance with the common art of ratiometric measurement approach, two planar secondary/sensing coils can be connected to one another in series, and in phase opposition, relatively to one another, and the innermost terminals of each secondary coils may be used to measure the differential output voltage, that is function of the angular position of the rotating conductive target, as shown in FIG. 2. This approach is directly valid for two planar secondary/sensing coils, but cannot be directly used here, because instead of two planar secondary/sensing coils of the common art, there are sixteen planar secondary/sensing coils, such as eight planar secondary/sensing coils in each coil set of two quartets, disposed in different layers that may lead to generate offset voltages among the different planar secondary/sensing coils, due to the different distances from the primary/excitation coil, and underlying induction couplings (M) differences. The goal is to generate time-varying output voltages 90° phase-shifted (e.g. sinθ and sin(θ+90°)), between the two coil sets of two quartets.

Therefore, with reference to FIG. 18 and FIG. 19, using the same reasoning of ratiometric measurement approach, by disposing the planar secondary/sensing coils in order to sense the desired coil output voltages with negative or positive magnitudes in a series circuit, in accordance with each relative quadrant where each planar secondary/sensing coils 321, 322, 323, 324, 325, 326, 327, 328, 331, 332, 333, 334, 335, 336, 337, and 338 pertains on the trigonometric circle, and connecting them in a way that final summation of the unitary contributions of all planar secondary/sensing equal to zero in the absence of the partially metallized disk-shaped target, a similar and equally usable result can be obtained.

In the sequel, it is demonstrated that the physical and electrical arrangements of the primary/excitation coil 311 and of the secondary/sensing coils 321, 322, 323, 324, 325, 326, 327, 328, 331, 332, 333, 334, 335, 336, 337, and 338 lead to the cancelation of the undesired voltage offsets among the different planar secondary/sensing coils.

Considering the ratiometric measurement approach, and implementing the analysis of the electric circuital meshes 320 and 330, in the condition of absence of the partially metallized disk-shaped target, whatever the value of the excitation source sin(ωt) 312, the value of Vₛᵢₙ 329 and V_{cos} 339 should be equal to zero.

However, as mentioned before, the different distances between the primary/excitation coil and the secondary/sensing coils laying in different PCB layers, imply the obtaining of offset voltages ΔVₛ between the secondary/sensing coils in layer 119 and layer 120, in the electric circuit of Vₛᵢₙ 329, and offset voltages ΔV_{c} between the secondary/sensing coils in layer 121 and layer 122, in the circuit of V_{cos} 339. These offset voltages are canceled if the secondary/sensing coils are arranged in the innovative way described in this patent, as is shown next.

So, firstly computing Vₛᵢₙ 329, by using the mesh's law, by considering ΔVₛ, the offset voltages between the layers 119 and 120 in the circuit loop 320, is obtained the following expression:

Vₛᵢₙ=V_{A}_{ₛ}_{⁺}=V_{B}_{ₛ}_{⁺}=V_{C}_{ₛ}_{^{−}}=V_{D}_{ₛ}_{^{−}}+(V_{A′}_{ₛ}_{⁺}+ΔV_{A′}_{ₛ}_{⁺})+(V_{B′}_{ₛ}_{⁺}+ΔV_{B′}_{ₛ}_{⁺})−(V_{C′}_{ₛ}_{^{−}}+ΔV_{C′}_{ₛ}_{^{−}})−(V_{D′}_{ₛ}_{^{−}}+ΔV_{D′}_{ₛ}_{^{−}}) (iii)

As {A, B, C, D} are in same layer and {A′, B′, C′, D′ } are in another one and all windings have the same number of turns, with the notation adopted in expression (iii) above it turns out that ΔV_{A′}_{ₛ}_{⁺}=ΔV_{B′}_{ₛ}_{⁺}=ΔV_{C′}_{ₛ}_{^{−}}=ΔV_{D′}_{ₛ}_{^{−}}=ΔVₛ and V_{A}_{ₛ}_{⁺}=V_{B}_{ₛ}_{⁺}=V_{C}_{ₛ}_{^{−}}=V_{D}_{ₛ}_{^{−}}=V_{A′}_{ₛ}_{⁺}=V_{B′}_{ₛ}_{⁺}=V_{C′}_{ₛ}_{^{−}}=V_{D′}_{ₛ}_{^{−}}. Using these equalities in (iii) leads, as desired, to

Vₛᵢₙ=0.

A similar reasoning can be used to demonstrate that V_{cos}=0.

From the above results, it may be concluded that the innovative arrangement of the circuits of secondary/sensing coils and of PCB layers preserves the principle of the ratiometric measurement approach, resulting in a completely balanced electric circuit as if it were positioned in the same layer of the PCB.

Again with reference to FIG. 18 and FIG. 19, a first coil set of two quartets 320, is disposed in two different layers of the multilayer PCB 119 and 120, connected in such way, by including a series circuit of four clockwise secondary/sensing coils 321, 322, 323, and 324 and two counterclockwise secondary/sensing coils 325, 326, 327, and 328, to generate one-phase of time-varying output voltage designated Vₛᵢₙ 329, and a second coil set of two quartets 330 disposed in another two different layers of the multilayer PCB 121 and 122, connected in another determined way, by including a series circuit of two clockwise secondary/sensing coils 331, and 332, four counterclockwise secondary/sensing coils 333, 334, 335, and 336, an two more clockwise secondary/sensing coil 337, and 338, to generate another phase of time-varying output voltage designated V_{cos} 339, leading to obtaining a resolver device.

The first coil set 320 of time-varying output voltage designated Vₛᵢₙ 329 is physically constructed through the secondary/sensing coils layers 119, and 120, with one voltage pole in the outer terminal of clockwise secondary/sensing coil Aₛ⁺ on PCB layer 119, interconnected by the use of vias, pads, and/or conductive tracks with the connections layer 117, that leads the time-varying output voltage designated Vₛᵢₙ 329 to application customizable electronic circuits on layers 102 and 103, and the inner terminal of secondary/sensing coil Aₛ⁺ on PCB layer 119, is interconnected by the use of vias, pads, and/or conductive tracks to the inner terminal of clockwise secondary/sensing coil A′ₛ⁺ on PCB layer 120, that coil having its outer terminal interconnected by the use of vias, pads, and/or conductive tracks to the outer terminal of the clockwise secondary/sensing coil B′ₛ⁺ on PCB layer 120, that coil having the inner terminal interconnected by the use of vias, pads, and/or conductive tracks to the inner terminal of clockwise secondary/sensing coil Bₛ⁺ on PCB layer 119, that same coil having its outer terminal interconnected by the use of vias, pads, and/or conductive tracks to the outer terminal of counterclockwise secondary/sensing coil Cₛ⁻ on PCB layer 119, which is interconnected by the use of vias, pads, and/or conductive tracks to the inner terminal of counterclockwise secondary/sensing coil C′ₛ_{^{−}} on PCB layer 120, that same coil having its outer terminal interconnected by the use of vias, pads, and/or conductive tracks to the outer terminal of counterclockwise secondary/sensing coil D′ₛ⁻ on PCB layer 120, which inner terminal is interconnected by the use of vias, pads, and/or conductive tracks to the inner terminal of counterclockwise secondary/sensing coil D′ₛ⁻ on PCB layer 119, which outer terminal is interconnected by the use of vias, pads, and/or conductive tracks to the connections layer 117, that leads the other voltage pole of the time-varying output voltage designated Vₛᵢₙ 329 to the application-specific standardization electronic circuits on layers 102 and 103.

The second coil set 330 of time-varying output voltage designated V_{cos} 339 is physically constructed through the secondary/sensing coils layers 121, and 122, with one voltage pole in the outer terminal of clockwise secondary/sensing coil A_{c}⁺ on PCB layer 121, interconnected by the use of vias, pads, and/or conductive tracks to the connections layer 117, that leads the time-varying output voltage designated V_{cos} 339 to the application-specific standardization electronic circuits on layers 102 and 103, and the inner terminal of secondary/sensing coil A_{c}⁺ on PCB layer 121, interconnected by the use of vias, pads, and/or conductive tracks to the inner terminal of clockwise secondary/sensing coil A′_{c}⁺ on PCB layer 122, which outer terminal is interconnected by the use of vias, pads, and/or conductive tracks to the outer terminal of counterclockwise secondary/sensing coil B′_{c}⁻ on PCB layer 122, which inner terminal is interconnected by the by the use of vias, pads, and/or conductive tracks to the inner terminal of counterclockwise secondary/sensing coil B_{c}⁻ on PCB layer 121, that same coil having the outer terminal interconnected by the use of vias, pads, and/or conductive tracks to the outer terminal of counterclockwise secondary/sensing coil C_{c}⁻ on PCB layer 121, which is interconnected by the use of vias, pads, and/or conductive tracks to the inner terminal of counterclockwise secondary/sensing coil C′_{c}⁻ on PCB layer 122, that same coil having the outer terminal interconnected by the use of vias, pads, and/or conductive tracks to the outer terminal of clockwise secondary/sensing coil D′_{c}⁺ on PCB layer 122, which inner terminal is interconnected by the use of vias, pads, and/or conductive tracks to the inner terminal of clockwise secondary/sensing coil D_{c}⁺ on PCB layer 121, which outer terminal is interconnected by the use of vias, pads, and/or conductive tracks to the connections layer 117, that leads the other voltage pole of time-varying output voltage designated V_{cos} 339 to the application-specific standardization electronic circuits on layers 102 and 103.

The first coil set 320 and the second coil set 330 generate the two-phase of time-varying output voltages, designated Vₛᵢₙ 329 and designated V_{cos} 339, as characteristic of a resolver device, which in the case are arranged in such a manner that the time-varying output voltages are 90° phase-shifted (e.g. sinθ and sin(θ+90°)).

In a particular embodiment, the primary/excitation coil 311 comprises five turns and the secondary/sensing coils 321, 322, 323, 324, 325, 326, 327, 328, 331, 332, 333, 334, 335, 336, 337, and 338 comprise six turns. The number of turns of the primary/excitation coil and of the secondary/sensing coils may be adjusted to particular variants.

With reference to FIG. 20 and FIG. 21, are presented, in a form of table, and of chart, the two-phases of time-varying output voltages, designated Vₛᵢₙ 329 and designated V_{cos} 339, as a function of the rotation angle of the partially metallized disk-shaped target for one embodiment of the schematic of FIG. 18 and FIG. 19.

According to the present invention and the current embodiment, the rotation displacement decoder device has been described to have two-phases of time-varying output voltages as characteristically generated by a resolver, but it can also be built to have three-phases of time-varying output voltages as characteristically generated by a synchro device, which in such case, should be designed three sets of planar secondary/sensing coils, arranged in such a manner that the time-varying output voltages are 120° phase-shifted (e.g. sinθ, sin(θ+120°), and sin(θ+240°)). The same reasoning is valid to build multi-phase devices of time-varying output voltages.

The designated stator set part, that comprises the planar electrical connections layer, the EMI shielding layer, the primary/excitation coil layer, and the planar secondary/sensing coils layers, connected and disposed in innovative manner, allows simple and easy interconnections of signals, addressed through the minimal use of vias, half-vias, pads, and/or conductive tracks, among the PCB layers.

The high sensitivity of planar secondary/sensing coils layers, connected and disposed in the innovative manner described in this patent, allows high accuracy, precision, linearity, and resolution of the device, by the use of simple, not expensive, and low-consumption analog and/or digital conditioning and/or processing circuits for standardization of the device's analog/digital interfaces, which are advantageous in power-constrained and/or mass-market field system applications.

The standardization or customization of time-varying output voltages for proper operation in a field system application are based in electronic circuits that may be implemented by one or more electronic components that are placed and soldered on determined PCB layers, through the use of vias, half-vias, pads, and/or conductive tracks, among the PCB layers, in accordance with the common art.

Unless otherwise specifically stated, is here expected that sentences using terms such “measuring”, “computing”, “generating”, “conditioning”, “processing”, “decoding”, or similar, can refer to the actions and/or processes of a computer system, or a similar electronic computing device, such as a microcontroller, a digital signal processor, or a hybrid or analog/digital processor, that manipulate and/or transform data, represented as physical quantities, in digital and/or analog form, within their registers, memories, or other similar information/data storage, transmission, or user interface devices.

For purposes well enlightenment, specific details are presented to allow a clear understanding of the current invention. Thus, is completely clear that the current invention may be implemented without those details.

In this patent application, some entities known in the current art, such as electronic circuits, physical circuits, electronic schematics, or similar, are shown partially, or in reduced form, rather than in detail, in order to simplify the understanding of the presented contents.

For purposes of understanding the embodiments of the current invention, it is expected that several terms are to be understood by whom trained in the art to describe experiences, techniques, and approaches.

All the embodiments here disclosed are described in enough detail to enable those who are trained in the art to put in practice the invention, and implement other similar or equivalent embodiments through several changes within the same scope of the current invention.

### REFERENCES

[1] Patent U.S. Ser. No. 10/415,952 Angular Position Sensor and Associated Method of Use.
[2] Patent U.S. Pat. No. 7,576,533 Inductive Angular-Position Sensor.
[3] Patent U.S. Ser. No. 10/330,498 Sensor Arrangement for the Contactless Sensing of Angles of Rotation on a RotatingPart.

What is claimed is:

1. An angular displacement decoder device and a method of construction of the device, comprising:
a designated stator set, as a cylindrical stack, including a planar primary coil, as the source of excitation, designated as planar primary/excitation coil, a plurality of planar secondary coils, as sensing elements, designated as planar secondary/sensing coils, disposed and interconnected in the determined innovative manner described, a plurality of electromagnetic interference (EMI) shielding layers, distributed by a plurality of layers of multilayer printed circuit boards (PCB), a shielded multi-conductor cable, and a thermoplastic case;
a designated rotor set, as a rotating conductive partially metalized disk-shaped target, rotating relatively to designated stator set, having a shape and composition in form of an air gap between the designated rotor set and the designated stator set and to cause a variation in induction coupling (M) between the designated planar primary coil and planar secondary coils on designated stator set in response to a rotating position of designated rotor set, and where the designated planar primary/excitation coil is excited by a source of excitation comprising a source of time-varying periodic waveform, sinusoidal or non-sinusoidal waveform, for example, a square wave, whereby the time-varying output voltages from the planar secondary/sensing coils are immediately present, and where the designated planar secondary/sensing coils are based in different forms as duets, triplets, quartets, or even higher forms, as sets of two planar secondary/sensing coils, of three planar secondary/sensing coils, of four planar secondary/sensing coils respectively, or of higher order forms (for example, hexets) of planar secondary/sensing coils, as ways of obtaining different sensitivities, accuracies, precisions, linearities, and resolutions of the device, and where the designated rotor set, that comprises a rotating conductive target, as a partially metallized disk-shaped target where the conductive part has the shape of a circular sector that may have a multitude of center angles preferably, from but not restricted to, between 90° and 270°, and where the designated rotor set part, that comprises a rotating conductive partially metallized disk-shaped target where the conductive part is shaped as a circular sector, is the cause of variations in induction coupling (M) between the planar primary/excitation coils and the planar secondary/sensing coils due to Foucault currents effects, as a function of the overlap in designated stator set, in response to its current rotating position, with underlying variations of the induced time-varying differential voltages in planar secondary/sensing coils, and where the method for construction is through the deployment of five steps, as:
(i) Choosing the desired number of phases of time-varying output voltages;
(ii) Choosing the angle shifting between the phases of the time-varying output voltages;
(iii) Choosing the factor of sensitivity (FS) of the device by computing the number of planar secondary/sensing coils;
(iv) Distributing the planar secondary/sensing coils by the layers of the multilayer printed circuit board (PCB) in accordance with individual coils polarity voltages versus the relative position in the trigonometric circle to obtain the desired time-varying output voltages by each angular position;
(v) Arranging the individual physical circuit of planar secondary/sensing coils addressed for obtaining the maximal symmetry relatively to the axis of revolution and the minimal use of vias, half-vias, pads, and/or conductive tracks, among the PCB layers.

2. The angular displacement decoder of claim 1, where the designated rotor set and the designated stator set are aligned perpendicularly with a common axis of revolution inside of the same delimitation line of the circumference of the entire decoder set, shaped as a cylindrical stack, formed by the different layers of the multilayer PCBs, where the partially metallized disk-shaped target that rotates around the same axis of revolution, is disposed with an air gap at determined distance from the stator set, where the designated rotor set part, that comprises a rotating conductive target, as a partially metallized disk-shaped target, is coupled to a gearing mechanism, or by another similar means, to a rotating body shaft, that is driven in rotation along its axis of revolution, and is part of a field application system that typifies the angular position-decoding systems for the computation of the displacement angles of rotating actuators in controlled or regulated mechanisms, and in metering devices.

3. The angular displacement decoder of claim 1, where the designated stator set part comprises a plurality of electromagnetic interference (EMI) shielding layers which have the function of allowing the compliance with legal and regulatory requirements and of avoiding the electromagnetic and/or magnetic perturbations, either by susceptibility to emissions by external sources, both random from the electromagnetic environment, or intentional with the purpose of fraud, or to emissions by the device as the own source for the electromagnetic interference;

4. The angular displacement decoder of claim 1, where the designated stator set part comprises planar connection layers, as mean of interconnecting the different multilayer PCBs of the stator set part, a planar ground plan layer, a designated first electronic circuit layer, a designated second electronic circuit layer, a modular male connector and a modular female connector, and half-vias, for the standardization or customization of the time-varying output voltages for proper operation in a system application.

5. The angular displacement decoder of claim 1, further comprising a shielded multi-conductor cable used for bidirectional transmission of standardized digital data and for powering the device, that includes a sleeve sheath to preserve the mechanical integrity of the cable, a thermoplastic case that encapsulates all the parts of the device and a mechanical mean of fitting the device to a mechanical static part, of the field application system, such as, but not restricted to, a bi-adhesive tape layer, or screws.

6. An angular displacement decoder device, comprising:
a designated stator set, as a cylindrical stack, including a planar primary coil as the source of excitation, designated as planar primary/excitation coil which is disposed in a determined number of layers of a multilayer PCB;
a plurality of planar secondary coils as sensing elements, designated as planar secondary/sensing coils, in a form of a cylindrical stack, that comprises two phases of time-varying output voltages having a factor of sensitivity (FS) of two and an angle shifting between the phases of time-varying output voltages of 90°, the said secondary coils being disposed and interconnected in a determined innovative manner described in this patent, arranged in duets, the two coils being disposed symmetrically relatively to the axis of revolution (one rotated 180° relatively to the other), each duet of each phase of output voltages is disposed in one same layer of multilayer PCB, one phase of output voltage in one layer, another phase of output voltage in another layer, where the planar secondary/sensing coils are disposed in order to sense the desired coil output voltages with negative or positive magnitudes in a series circuit, in accordance with each relative quadrant where each planar secondary/sensing coil pertains on the trigonometric circle, and are connected in a way that final summation of the unitary contributions of all planar secondary/sensing coils equal to zero in the absence of the partially metallized disk-shaped target, and in which a first coil set of two duets is disposed in two different layers of the multilayer PCB, interconnected in such way, by including a series circuit of two clockwise secondary/sensing coils and two counterclockwise secondary/sensing coils, as to generate one-phase of time-varying output voltage designated Vₛᵢₙ, and where a second coil set of two duets is disposed in another two different layers of the multilayer PCB, interconnected in another determined described way, by including a series circuit of one clockwise secondary/sensing coil, two counterclockwise secondary/sensing coils, an one more clockwise secondary/sensing coil, to generate another phase of time-varying output voltage designated V_{cos}, as a function of the rotation angle θ of the partially metalized disk-shaped target, the two phases coils sets being arranged in such a manner that the time-varying output voltages are 90° phase-shifted (e.g. sinθ and sin(θ+90°), as characteristic of a resolver device, and where the first coil set of time-varying output voltage, designated Vₛᵢₙ, is physically constructed through the secondary/sensing coils layers, with one voltage pole in the outer terminal of clockwise secondary/sensing coil Aₛ⁺ on a first secondary/sensing coils PCB layer, interconnected by the use of vias, pads, and/or conductive tracks with the connections layer, that leads the time-varying output voltage designated Vₛᵢₙ to standardization electronic circuits layers, and the inner terminal of secondary/sensing coil Aₛ⁺ on the designated first secondary/sensing coils PCB layer, interconnected by the use of vias, pads, and/or conductive tracks with the outer terminal of clockwise secondary/sensing coil Bₛ⁺ on the second secondary/sensing coils PCB layer, and the inner terminal interconnected by the use of vias, pads, and/or conductive tracks with the inner terminal of counterclockwise secondary/sensing coil Cₛ⁻ on the designed first secondary/sensing coils PCB layer, and the outer terminal interconnected by the use of vias, pads, and/or conductive tracks with the inner terminal of counterclockwise secondary/sensing coil DS on the designated second secondary/sensing coils PCB layer, and the outer terminal interconnected by the use of vias, pads, and/or conductive tracks with the connections layer, that leads the other voltage pole of the time-varying output voltage designated Vₛᵢₙ to standardization electronic circuits,
and where the second coil set of time-varying output voltage, designated V_{cos}, is physically constructed through two other secondary/sensing coils layers, with one voltage pole in the outer terminal of clockwise secondary/sensing coil A_{c}⁺ on a third secondary/sensing coils PCB layer, interconnected by the use of vias, pads, and/or conductive tracks with the connections layer, that leads the time-varying output voltage designated V_{cos} to standardization electronic circuits layers, and the inner terminal of secondary/sensing coil A_{c}⁺ on the designated third secondary/sensing coils PCB layer, interconnected by the use of vias, pads, and/or conductive tracks with the inner terminal of counterclockwise secondary/sensing coil on the fourth secondary/sensing coils PCB layer, and the outer terminal interconnected by the use of vias, pads, and/or conductive tracks with the inner terminal of counterclockwise secondary/sensing coil C_{c}⁻, on the designated third secondary/sensing coils PCB layer, and the outer terminal interconnected by the use of vias, pads, and/or conductive tracks with the outer terminal of the clockwise secondary/sensing coil D_{c}⁺ on the fourth secondary/sensing coils PCB layer, and the inner terminal interconnected by the use of vias, pads, and/or conductive tracks with the connections layer, that leads the other voltage pole of time-varying output voltage designated V_{cos} to standardization electronic circuits layers;
a plurality of electromagnetic interference (EMI) shielding layers, distributed by a plurality of layers of multilayer printed circuit boards (PCB);
a shielded multi-conductor cable;
a thermoplastic case; and
a designated rotor set, comprising a rotating conductive partially metallized disk-shaped target where the conductive part is shaped as a circular sector, rotating relatively to designated stator set, existing an air gap between the designated rotor set and the designated stator set, the said rotor causing a variation in induction coupling (M) between the designated planar primary coils and planar secondary coils on designated stator set in response to a rotating position of designated rotor set, which produces variations of the induced time-varying differential voltages in planar secondary/sensing coils, and where the said circular sector conductive part of the designated rotor may include a multitude of center angles, from but not restricted to, the range of 90° to 270°,
and where the designated rotor set and the designated stator set are aligned perpendicularly with the same axis of revolution inside of the same delimitation line of the circumference of the entire decoder set, shaped as a cylindrical stack, formed by the different layers of the multilayer PCBs, where the partially metallized disk-shaped target rotates around the same axis of revolution, is disposed with an air gap at determined distance from the stator set.

7. The angular displacement decoder of the previous claim, where the designated planar primary/excitation coil is excited by a source of excitation, comprising a source of time-varying periodic waveform, whereby the time-varying output voltages from the planar secondary/sensing coils are immediately present.

8. The angular displacement decoder of claim 6, where the designated rotor set part, that comprises a rotating conductive target, as a partially metallized disk-shaped target, is coupled by a gearing mechanism, or by another similar means, to a rotating body shaft, that is driven in rotation along its axis of revolution, and can be part of a field application system that typifies the angular position-decoding systems for the computation of the displacement angles of rotating actuators in controlled or regulated mechanisms, and in metering devices.

9. The angular displacement decoder of claim 6, where the designated stator set part comprises planar connection layers, as mean of interconnecting the different multilayer PCBs of the stator set part, a planar ground plane layer, a designated first electronic circuit layer, a designated second electronic circuit layer, having a modular male connector and a modular female connector, and half-vias, for the standardization or customization of the time-varying output voltages for proper operation in a system application.

10. The angular displacement decoder of claim 6, comprising three sets of planar secondary/sensing coils producing three-phases of time-varying output voltages, and arranged in such a manner that the time-varying output voltages are 120° phase-shifted (e.g. sinθ, sin(θ+120°) and sin(θ+240°)).

11. An angular displacement decoder device, comprising:
a designated stator set, as a cylindrical stack, including a planar primary coil, as the source of excitation, designated as planar primary/excitation coil which is disposed in a determined number of layers of a multilayer PCB;
a plurality of planar secondary coils as sensing elements, designated as planar secondary/sensing coils, in a form of a cylindrical stack that comprises two phases of time-varying output voltages having a factor of sensitivity (FS) of three and an angle shifting between the phases of time-varying output voltages of 120°, the said secondary coils being disposed and interconnected in determined innovative manner described in this patent, arranged and disposed in triplets in each layer, with each one planar secondary/sensing coil rotated 120° with each other relatively to the axis of revolution, where two triplets generate one phase output voltage, and the other two triplets generate another phase output voltage, where the planar secondary/sensing coils are disposed in order to sense the desired coil output voltages with negative or positive magnitudes in a series circuit, in accordance with each relative quadrant where each planar secondary/sensing coil pertains on the trigonometric circle, and are connected in a way that final summation of the unitary contributions of all planar secondary/sensing coils is small in the absence of the partially metallized disk-shaped target, and in which a first coil set of two triplets is disposed in two different layers of the multilayer PCB, connected in such way, by including a series circuit of three clockwise secondary/sensing coils and three counterclockwise secondary/sensing coils, as to generate one-phase of time-varying output voltage designated Vₛᵢₙ, and a second coil set of two triplets is disposed in another two different layers of the multilayer PCB, interconnected in another determined described way, by including a series circuit of one clockwise secondary/sensing coil, three counterclockwise secondary/sensing coils, and two more clockwise secondary/sensing coils, to generate another-phase of time-varying output voltage designated V_{cos}, as a function of the rotation angle of the partially metallized disk-shaped target, the two phases coils sets being arranged in such a manner that the time-varying output voltages are 120° phase-shifted (e.g. sinθ and sin(θ+120°), as characteristic of a resolver device,
and where the first coil set of time-varying output voltage designated Vₛᵢₙ is physically constructed through the secondary/sensing coils layers, with one voltage pole in the inner terminal of clockwise secondary/sensing coil Aₛ⁺ on a first secondary/sensing coil PCB layer, interconnected by the use of vias, pads, and/or conductive tracks with the connections layer, that leads the time-varying output voltage designated Vₛᵢₙ to standardization electronic circuits layers, and the outer terminal of secondary/sensing coil Aₛ⁺ on a same designated first secondary/sensing coils PCB layer, interconnected by the use of vias, pads, and/or conductive tracks with the inner terminal of clockwise secondary/sensing coil Bₛ⁺ on a second secondary/sensing coils PCB layer, and the outer terminal interconnected by the use of vias, pads, and/or conductive tracks with the inner terminal of clockwise secondary/sensing coil Cₛ⁺ on the designated first secondary/sensing coils PCB layer, and the outer terminal interconnected by the use of vias, pads, and/or conductive tracks with the inner terminal of counterclockwise secondary/sensing coil Dₛ⁻ on the designated second secondary/sensing coils PCB layer, and the outer terminal interconnected by the use of vias, pads, and/or conductive tracks with the inner terminal of counterclockwise secondary/sensing coil Eₛ⁻ on the designated first secondary/sensing coils PCB layer, and the outer terminal interconnected by the use of vias, pads, and/or conductive tracks with the inner terminal of counterclockwise secondary/sensing coil Fₛ⁻ on the designated second secondary/sensing coils PCB layer, and the outer terminal interconnected by the use of vias, pads, and/or conductive tracks with the connections layer, that leads the other voltage pole of time-varying output voltage designated Vₛᵢₙ to standardization electronic circuits,
and where the second coil set of time-varying output voltage designated V_{cos} is physically constructed through the secondary/sensing coils layers, with one voltage pole in the inner terminal of clockwise secondary/sensing coil A_{c}⁺ on a third secondary/sensing coils PCB layer, interconnected by the use of vias, pads, and/or conductive tracks with the connections layer, that leads the time-varying output voltage designated V_{cos} to standardization electronic circuits layers, and the outer terminal of secondary/sensing coil A_{c}⁺ on a same designated third secondary/sensing coils PCB layer, interconnected by the use of vias, pads, and/or conductive tracks with the inner terminal of the counterclockwise secondary/sensing coil B_{c}⁻ on a fourth secondary/sensing coils PCB layer, and the outer terminal interconnected by the use of vias, pads, and/or conductive tracks with the inner terminal of counterclockwise secondary/sensing coil C_{c}⁻ on the designated third secondary/sensing coils PCB layer, and the outer terminal interconnected by the use of vias, pads, and/or conductive tracks with the inner terminal of counterclockwise secondary/sensing coil D_{c}⁻ on the designated fourth secondary/sensing coils PCB layer, and the outer terminal interconnected by the use of vias, pads, and/or conductive tracks with the inner terminal of clockwise secondary/sensing coil E_{c}⁺ on the designated third secondary/sensing coils PCB layer, and the outer terminal interconnected by the use of vias, pads, and/or conductive tracks with the inner terminal of clockwise secondary/sensing coil F_{c}⁺ on the designated fourth secondary/sensing coils PCB layer, and the outer terminal interconnected by the use of vias, pads, and/or conductive tracks with the connections layer, that leads the other voltage pole of time-varying output voltage designated V_{cos} to standardization electronic circuits layers;
a plurality of electromagnetic interference (EMI) shielding layers, distributed by a plurality of layers of multilayer printed circuit boards (PCB);
a shielded multi-conductor cable;
a thermoplastic case; and
a designated rotor, comprising a rotating conductive partially metallized disk-shaped target where the conductive part is shaped as a circular sector, rotating relatively to designated stator set, existing an air gap between the designated rotor set and the designated stator set, said rotor causing a variation in induction coupling (M) between the designated planar primary coils and planar secondary coils on designated stator set in response to a rotating position of designated rotor set, which produces variations of the induced time-varying differential voltages in planar secondary/sensing coils, and where the said circular sector conductive part of the designated rotor may include a multitude of center angles, from but not restricted to, the range of 90° to 270°,
and where the designated rotor set and the designated stator set that are aligned perpendicularly with the same axis of revolution inside of the same delimitation line of the circumference of the entire decoder set, shaped as a cylindrical stack, formed by the different layers of the multilayer PCBs, where the partially metallized disk-shaped target that rotates around the same axis of revolution, is disposed with an air gap at determined distance from the stator set.

12. The angular displacement decoder of claim 11, where the designated planar primary/excitation coil is excited by a source of excitation, comprising a source of time-varying periodic waveform, whereby the time-varying output voltages from the planar secondary/sensing coils are immediately present.

13. The angular displacement decoder of claim 11, where the designated rotor set part, which comprises a rotating conductive target, as a partially metallized disk-shaped target, is coupled by a gearing mechanism, or by another similar means, to a rotating body shaft, that is driven in rotation along its axis of revolution, and can be part of a field application system that typifies the angular position-decoding systems for the computation of the displacement angles of rotating actuators in controlled or regulated mechanisms, and in metering devices.

14. The angular displacement decoder of claim 11, where the designated stator set part comprises planar connection layers, as mean of interconnecting the different multilayer PCBs of the stator set part, a planar ground plane layer, a designated first electronic circuit layer, a designated second electronic circuit layer, having a modular male connector and a modular female connector, and half-vias, for the standardization or customization of the time-varying output voltages for proper operation in a system application.

15. The angular displacement decoder of claim 11, comprising three sets of planar secondary/sensing coils producing three-phases of time-varying output voltages, and arranged in such a manner that the time-varying output voltages are 120° phase-shifted (e.g. sinθ, sin(θ+120°) and sin(θ+240°)).

16. An angular displacement decoder device, comprising:
a designated stator set, as a cylindrical stack, including a planar primary coil, as the source of excitation, designated as planar primary/excitation coil which is disposed in a determined number of layers of a multilayer PCB;
a plurality of planar secondary coils, as sensing elements, designated as planar secondary/sensing coils, in a form of a cylindrical stack, that comprises two phases of time-varying output voltages having a factor of sensitivity (FS) of four and an angle shifting between the phases of time-varying output voltages of 90°, the said secondary coils being disposed and interconnected in determined innovative manner described in this patent, arranged and disposed in quartets by each layer, with each one planar secondary/sensing coil rotated 90° relatively to the axis of revolution, where two quartets generate one phase output voltage, and the other two quartets generate another phase output voltage, where the planar secondary/sensing coils are disposed in order to sense the desired coil output voltages with negative or positive magnitudes in a series circuit, in accordance with each relative quadrant where each planar secondary/sensing coil pertains on the trigonometric circle, and are connected in a way that final summation of the unitary contributions of all planar secondary/sensing coils equal to zero, in the absence of the partially metallized disk-shaped target,
and in which a first coil set of two quartets is disposed in two different layers of the multilayer PCB, connected in such way, by including a series circuit of four clockwise secondary/sensing coils and four counterclockwise secondary/sensing coils, as to generate one-phase of time-varying output voltage designated Vₛᵢₙ, and a second coil set of two quartets is disposed in another two different layers of the multilayer PCB, interconnected in another determined described way, by including a series circuit of two clockwise secondary/sensing coils, four counterclockwise secondary/sensing coils, an two more clockwise secondary/sensing coils, to generate another phase of time-varying output voltage designated V_{cos}, as a function of the rotation angle of the partially metallized disk-shaped target, the two phases coils sets being arranged in such a manner that the time-varying output voltages are 90° phase-shifted (e.g. sinθ and sin(θ+90°), as characteristic of a resolver device,
and where the first coil set of time-varying output voltage designated Vₛᵢₙ that is physically constructed through the secondary/sensing coils layers, with one voltage pole in the outer terminal of clockwise secondary/sensing coil Aₛ⁺ on a first secondary/sensing coils PCB layer, interconnected by the use of vias, pads, and/or conductive tracks with the connections layer, that leads the time-varying output voltage designated Vₛᵢₙ to standardization electronic circuits layers, and the inner terminal of secondary/sensing coil Aₛ⁺ on the designated first secondary/sensing coils PCB layer, interconnected by the use of vias, pads, and/or conductive tracks with the inner terminal of clockwise secondary/sensing coil A′ₛ⁺ on a second secondary/sensing coils PCB layer, and the outer terminal interconnected by the use of vias, pads, and/or conductive tracks with the outer terminal of clockwise secondary/sensing coil B′ₛ⁺ on the designated second secondary/sensing coils PCB layer, interconnected by the inner terminal by the use of vias, pads, and/or conductive tracks with the inner terminal of clockwise secondary/sensing coil Bₛ⁺ on the designated first secondary/sensing coils PCB layer, and the outer terminal interconnected by the use of vias, pads, and/or conductive tracks with the outer terminal of counterclockwise secondary/sensing coil Cₛ⁻ on the designated first secondary/sensing coils PCB layer, whose inner terminal is interconnected by the use of vias, pads, and/or conductive tracks with the inner terminal of counterclockwise secondary/sensing coil C′ₛ⁻ on the designated second secondary/sensing coils PCB layer, and the outer terminal interconnected by the use of vias, pads, and/or conductive tracks with the outer terminal of counterclockwise secondary/sensing coil D′ₛ⁻ on the designated second secondary/sensing coils PCB layer, and the inner terminal interconnected by the use of vias, pads, and/or conductive tracks with the inner terminal of counterclockwise secondary/sensing coil Dₛ⁻ the designated first secondary/sensing coils PCB layer, and the outer terminal interconnected by the use of vias, pads, and/or conductive tracks with the connections layer, that leads the another voltage pole of time-varying output voltage designated Vₛᵢₙ to standardization electronic circuits,
and where the second coil set of time-varying output voltage designated V_{cos} is physically constructed through another two secondary/sensing coils layers, with one voltage pole in the outer terminal of clockwise secondary/sensing coil A_{c}⁺ on a third secondary/sensing coils PCB layer, interconnected by the use of vias, pads, and/or conductive tracks with the connections layer, that leads the time-varying output voltage designated V_{cos} to standardization electronic circuits layers, and the inner terminal of secondary/sensing coil A_{c}⁺ on the designated third secondary/sensing coils PCB layer, interconnected by the use of vias, pads, and/or conductive tracks with the inner terminal of clockwise secondary/sensing coil A′_{c}⁺ on a fourth secondary/sensing coils PCB layer, and the outer terminal interconnected by the use of vias, pads, and/or conductive tracks with the outer terminal of counterclockwise secondary/sensing coil B′_{c}⁻ on the designated fourth secondary/sensing coils PCB layer, interconnected by the inner terminal by the use of vias, pads, and/or conductive tracks with the inner terminal of counterclockwise secondary/sensing coil B_{c}⁻ on the designated third secondary/sensing coils PCB layer, and the outer terminal interconnected by the use of vias, pads, and/or conductive tracks with the outer terminal of counterclockwise secondary/sensing coil C_{c}⁻, on the designated third secondary/sensing coils PCB layer, interconnected by the use of vias, pads, and/or conductive tracks with the inner terminal of counterclockwise secondary/sensing coil C′_{c}⁻ on the designated fourth secondary/sensing coils PCB layer, and the outer terminal interconnected by the use of vias, pads, and/or conductive tracks with the outer terminal of clockwise secondary/sensing coil D′_{c}⁺ on the designated fourth secondary/sensing coils PCB layer, and the inner terminal interconnected by the use of vias, pads, and/or conductive tracks with the inner terminal of clockwise secondary/sensing coil D_{c}⁺ on a same designated third secondary/sensing coils PCB layer, and the outer terminal interconnected by the use of vias, pads, and/or conductive tracks with the connections layer, that leads the another voltage pole of time-varying output voltage designated V_{cos} to standardization electronic circuits layers;
a plurality of electromagnetic interference (EMI) shielding layers, distributed by a plurality of layers of multilayer printed circuit boards (PCB);
a shielded multi-conductor cable;
a thermoplastic case; and
a designated rotor, comprising a rotating conductive partially metallized disk-shaped target where the conductive part is shaped as a circular sector, rotating relatively to designated stator set, existing an air gap between the designated rotor set and the designated stator set, said rotor causing a variation in induction coupling (M) between the designated planar primary coils and planar secondary coils on designated stator set in response to a rotating position of the designated rotor set, which produces variations of the induced time-varying differential voltages in planar secondary/sensing coils,
and where the said circular sector conductive part of the designated rotor may include a multitude of center angles, from but not restricted to, the range of 90° to 270°,
and where the designated rotor set and the designed stator set that are aligned perpendicularly with the same axis of revolution inside of the same delimitation line of the circumference of the entire decoder set, shaped as a cylindrical stack, formed by the different layers of the multilayer PCBs, where the partially metallized disk-shaped target that rotates around the same axis of revolution, is disposed with an air gap at determined distance from the stator set.

17. The angular displacement decoder of claim 16, where the designated planar primary/excitation coil is excited by a source of excitation, comprising a source of time-varying periodic waveform, whereby the time-varying output voltages from the planar secondary/sensing coils are immediately present.

18. The angular displacement decoder of claim 16, where the designated rotor set part, that comprises a rotating conductive target as a partially metallized disk-shaped target, is coupled by a gearing mechanism, or by another similar means, to a rotating body shaft, that is driven in rotation along its axis of revolution, and can be part of a field application system that typifies the angular position-decoding systems for the computation of the displacement angles of rotating actuators in controlled or regulated mechanisms, and in metering devices.

19. The angular displacement decoder of claim 16, where the designated stator set part comprises planar connection layers, as mean of interconnecting the different multilayer PCBs of the stator set part, a planar ground plane layer, a designated first electronic circuit layer, a designated second electronic circuit layer, having a modular male connector and a modular female connector, and half-vias, for the standardization or customization of the time-varying output voltages for proper operation in a system application.

20. The angular displacement decoder of claim 16, comprising three sets of planar secondary/sensing coils producing three-phases of time-varying output voltages, and arranged in such a manner that the time-varying output voltages are 120° phase-shifted (e.g. sinθ, sin(θ+120°) and sin(θ+240°)).
